(19) United States
(12) Patent Application Publication
(10) Pub. No.: US 2019/0019437 A1
(43) Pub. Date: Jan. 17, 2019

(54) DISPLAY STAND

(71) Applicant: DIE DU TOIT FAMILIE TRUST, Durbanville (ZA)

(72) Inventors: Alphons Du Toit, Durbanville (ZA); George Alexis Hugo, Durbanville (ZA); Dietmar Norbert Renner, Stellenbosch (ZA)

(73) Assignee: DIE DU TOIT FAMILIE TRUST, Durbanville (ZA)

(21) Appl. No.: 16/080,139

(22) PCT Filed: Feb. 22, 2017
(86) PCT No.: PCT/IB2017/051009

§ 371 Date: Aug. 27, 2018

(30) Foreign Application Priority Data
Feb. 26, 2016 (ZA) 2016/01319

(51) Int. Cl. G09F 15/00

(52) U.S. Cl. CPC G09F 15/0025; G09F 2015/0093; G09F 15/0012

(57) ABSTRACT

A display stand is disclosed which includes a tensioning mechanism connecting a horizontal to a column (20), the column including a fixed lower component (78) and a movable upper component (76) which is able to move up and down with respect to the fixed component. A mechanism for releasably securing the horizontal to the movable component is provided and there is a “press to lock/press to release” latch (84, 86, 104, 106, 108, 110) joining the upper and lower components. A spring (144) pushes the upper component (76) upwards after the latch has been activated to release the upper component (76).

### FIELD OF THE INVENTION

THIS INVENTION relates to display stands.

### BACKGROUND TO THE INVENTION

One form of advertising sign which is commonly used comprises a printed fabric or plastics material panel which is fitted to a supporting display stand. For aesthetic purposes, it is desirable for the panel to be taut and hence be devoid of wrinkles and creases.

The present invention provides a display stand including means for securing an advertising panel and means for tensioning the panel once it is fixed to the stand.

### BRIEF DESCRIPTION OF THE INVENTION

According to the present invention there is provided a display stand including a tensioning mechanism connecting a horizontal to a column, the column including a fixed lower component and a movable upper component which is able to move up and down with respect to the fixed component, there being a mechanism for releasably securing the horizontal to the movable component, a “press to lock/press to release” latch joining the upper and lower components, and a spring for pushing the upper component upwards after said latch has been activated to release the upper component.

Said latch can comprise a cam track and a cam follower which moves with respect to said track during relative movement between said components, the cam follower holding said upper component in an intermediate position after the latch has performed a locking movement, and releasing the upper component upon the upper component being pressed down to a lower position so that the latch performs a press to release operation. In this form it is preferred that there be two cam tracks which face in opposite directions and two shells which together form a sheath around the cam tracks, each shell having a window in it and there being a cam follower pivotally mounted on the outside of each shell, the followers extending through the windows and having fingers which move along the cam tracks.

A blocking element forming part of the fixed component can be provided which has an operative position in which in prevents said upper component being displaced downward with respect to the lower component and an inoperative position it which it permits said downward displacement.

Said blocking element can be mounted for rotation between said positions and includes upstanding posts which engage a downwardly facing surface of the movable component when in its operative condition. Preferably, said blocking element is within a sleeve which has an opening in it and said blocking element includes an actuating member which protrudes from the sleeve through the opening.

In one form the mechanism for releasably securing the horizontal to the column comprises a pair of jaws which are moved by a cam to a withdrawn inoperative position and spring urged to their operative condition. A button can be provided which a guided for rectilinear travel and which has a set of parallel teeth on one face thereof, said cam including a cylindrical portion which is toothed, the teeth of the button meshing with the teeth of the cam to rotate the cam when the button moves rectilinearly. The cam can be wedge-like in form and increase in thickness from one end to the other, the cam being between said jaws.

In another form the releasable securing mechanism comprises a casing, a body rotatable in the casing and having a pair of diametrically opposed locking tabs, and an operating lever projecting from the casing through a slot in the casing for rotating the body through ninety degrees.

In this form of the releasable securing mechanism the locking tabs protrude from opposite sides of a threaded shaft, there being an internally threaded wheel structure screwed onto said shaft, said wheel structure being restrained against axial movement so that, when the wheel structure is rotated, said shaft is moved axially.

In a still further form the releasable securing mechanism comprises a casing having a cam track, a shaft mounted for rotation in said casing and having a diametrically opposed pair of locking tabs, an operating element pivotally mounted on said shaft and including a cam, the operating element being displaceable in a first swinging movement for rotating said shaft about its axis thereby to displace said tabs between an operative position and an inoperative position and in a second movement which causes said cam to move over said cam track and displace said shaft axially.

Said operating element can include a fork having tines, said shaft being between said tines and there being a pivot pin passing through aligned bores in the tines and the shaft whereby said operating element can rotate with the shaft about its axis and relative to the shaft about the axis of said pivot pin. There can further be surfaces on said casing and said operating element which are in contact and prevent said shaft being moved in said first swinging movement from the position it occupies when said tabs are in their operative position.

The display stand as defined above can include a base plate having an opening in it, the opening having recesses in the edge thereof, there being serrated edge sections of the opening between the recesses, a post, a connector at the lower end of the post, the connector having protruding locking tabs which can be passed through said recesses and which, when the post is rotated, move out of alignment with the recesses and secure the post to the base, a locking ring having teeth which interlock with said serrated edge sections to prevent the ring from rotating, and reverse threading on the ring and the connector which causes the non-rotatable ring to move axially into contact with the base plate when the post is rotated to latch it to the base.

### BRIEF DESCRIPTION OF THE DRAWINGS

For a better understanding of the present invention, and to show how the same may be carried into effect, reference will now be made, by way of example, to the accompanying drawings in which:

FIG. 1 is a pictorial view of the stand of an advertising sign which sign also includes a printed panel secured to the stand;

FIG. 2 is a pictorial view of one of the columns and associated base structure of the stand;

FIG. 3 is an “exploded” pictorial view of the components of the column and base structure;

FIG. 4 is a top plan view of the column and base structure of FIG. 3;

FIG. 5 is an underneath plan view of the column and base structure;

FIG. 6 is a side elevation of the column and base structure;

FIG. 7 is a pictorial view of a base plate of the base structure;

FIG. 8 is a top plan view of an aluminium extrusion;

FIGS. 9 and 10 are side elevations of a connector taken at right angles to one another;

FIGS. 11 and 12 are top and bottom plan views of the connector;

FIG. 13 is a pictorial view from above of a locking ring;

FIG. 14 is an underneath plan view of the locking ring;

FIG. 15 is a top plan view of the locking ring;

FIG. 16 is a pictorial view of the locking ring from below;

FIG. 17 is a side elevation of the locking ring;

FIGS. 18 and 19 are pictorial views of a locking element from above and below;

FIG. 20 is an “exploded” view of the components of a tensioning mechanism;

FIG. 21 is pictorial view of assembled tensioning mechanism;

FIG. 22 illustrates, to a larger scale, a detail of the tensioning mechanism;

FIG. 23 is a cut away pictorial view showing the tensioning mechanism in its extended condition;

FIG. 24 is a similar view but showing the mechanism in its telescoped condition;

FIGS. 25 to 27 are elevations of the tensioning mechanism from three different directions;

FIGS. 28 and 29 are a top plan view and a bottom plan view of the tensioning mechanism;

FIGS. 30 to 33 are respectively a pictorial view, a top plan view and two side elevations of a first component of the tensioning mechanism;

FIGS. 34 to 36 are respectively a pictorial view and two side elevations of a second component of the tensioning mechanism;

FIGS. 37 and 38 are respectively a pictorial view and a top plan view of a cap of the tensioning mechanism;

FIGS. 39 to 41 are respectively a pictorial view and two side elevations of a latching element;

FIG. 42 is an end view of the aluminium extrusion which constitute upper and lower crossbars of the stand;

FIG. 43 is an exploded pictorial view of a mechanism which releasably secure the ends of the upper and lower crossbars to the columns;

FIG. 44 is a pictorial view of the mechanism of FIG. 43;

FIG. 45 is a top plan view of a first housing part;

FIG. 46 is a plan view of the inside of a second housing part;

FIG. 47 is a pictorial view of an actuating button;

FIGS. 48 and 49 illustrate the securing mechanism and an extrusion, the mechanism being shown in two different positions;

FIGS. 50 and 51 illustrate latching jaws of the mechanism in their open and closed positions;

FIGS. 52 and 53 are sections illustrating the operation of the mechanism;

FIGS. 54 and 55 are respectively a pictorial view of a jaw actuating component and an elevation of the component;

FIGS. 56 and 57 are pictorial views from above and below of a further form of releasable securing mechanism;

FIGS. 58 and 59 are top and bottom plan views of the mechanism of FIGS. 56 and 57;

FIGS. 60 and 61 are end views of the mechanism of FIGS. 56 to 59;

FIG. 62 is a side elevation of this mechanism;

FIGS. 63 and 64 are pictorial view of an actuating element of the mechanism;

FIGS. 65 to 67 are side elevations of the element of FIGS. 63 and 64;

FIGS. 68 and 69 are pictorial views of a locking wheel;

FIG. 70 is a plan view of the locking wheel;

FIGS. 71 and 72 are views showing the releasable securing mechanism and an extrusion;

FIGS. 73 and 74 are sections on the lines A-A and B-B of FIGS. 71 and 72 through the mechanism and respectively show it in its secured and released conditions;

FIG. 75 is an “exploded” pictorial view of a further form of mechanism for releasably securing the ends of the upper and lower crossbars to the columns;

FIG. 76 is a top plan view of one of the casing parts of the mechanism of FIG. 75;

FIG. 77 is a pictorial view of showing the inside of the casing part of FIG. 76;

FIG. 78 is a pictorial view of the casing part of FIG. 76;

FIG. 79 is a pictorial view showing the outside of the other casing part;

FIG. 80 is a pictorial view showing the inside of the other casing part;

FIG. 81 is a side elevation of an actuating element;

FIG. 82 is a side elevation of a locking pin;

FIGS. 83 and 84 are views of the locking pin from opposite ends;

FIG. 85 is a side elevation of a forked locating element;

FIG. 86 is a pictorial view of the element of FIG. 85;

FIGS. 87 to 89 are pictorial views of the mechanism in different operating conditions; and

FIGS. 90 to 92 are plan views corresponding to FIGS. 87 to 89.

### DETAILED DESCRIPTION OF THE DRAWINGS

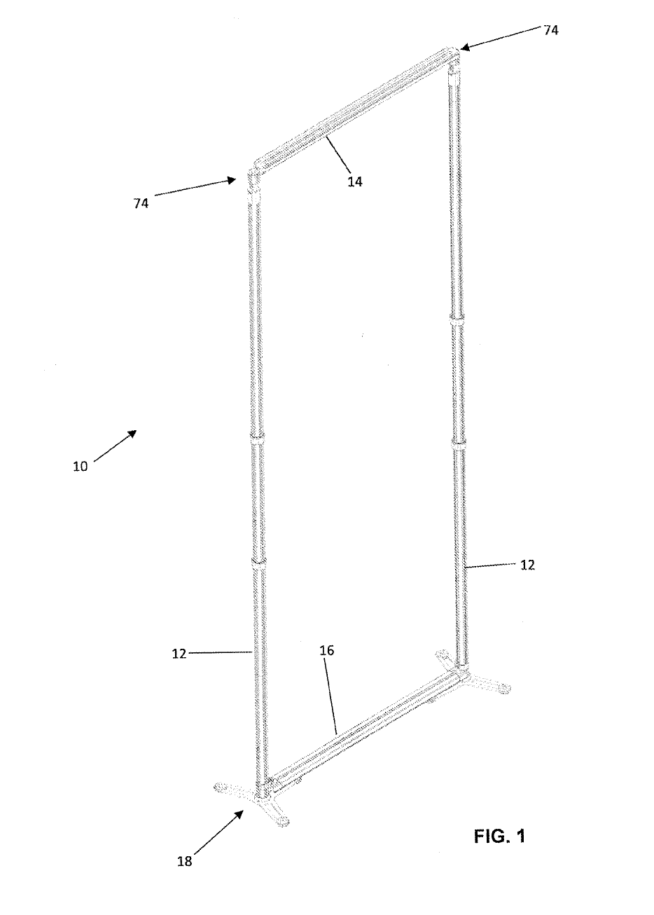

The stand 10 shown in FIG. 1 comprises two columns 12, an upper cross bar 14, a lower cross bar 16 and two base structures 18. The panel which carries the printed material is not shown in FIG. 1 but is secured to the upper and lower crossbars 14, 16.

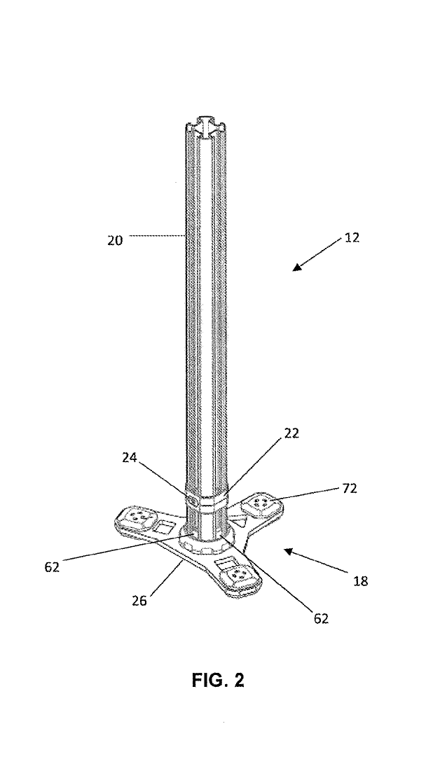

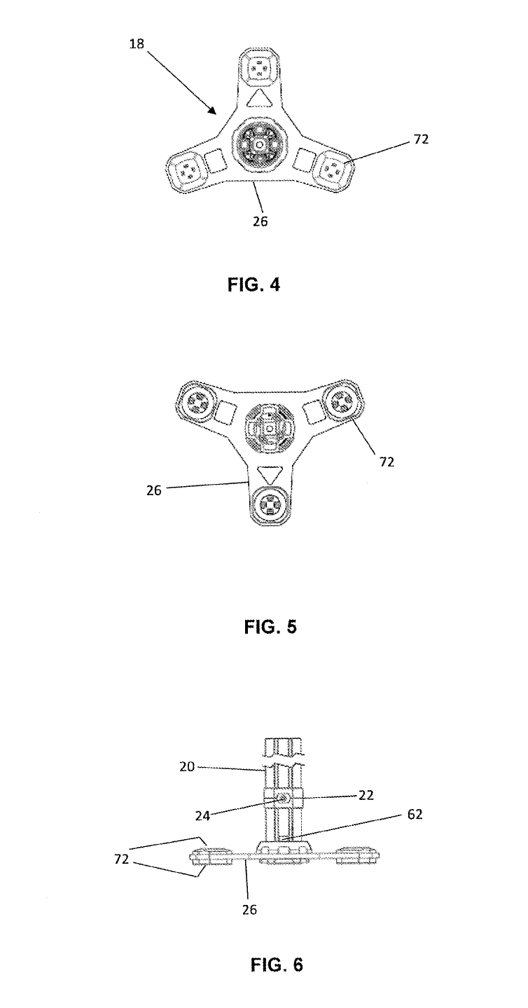

One of the columns 12 is shown in detail in FIGS. 2 to 7 and comprises an elongate aluminium extrusion 20 which constitutes the main component of the column. The cross sectional shape of the extrusion 20, which will be described in more detail later, is best seen in FIG. 8. Close to the lower end of each column 12 there is a collar 22 which is secured to the extrusion 20 by a screw 24. The collars form stops as will be described.

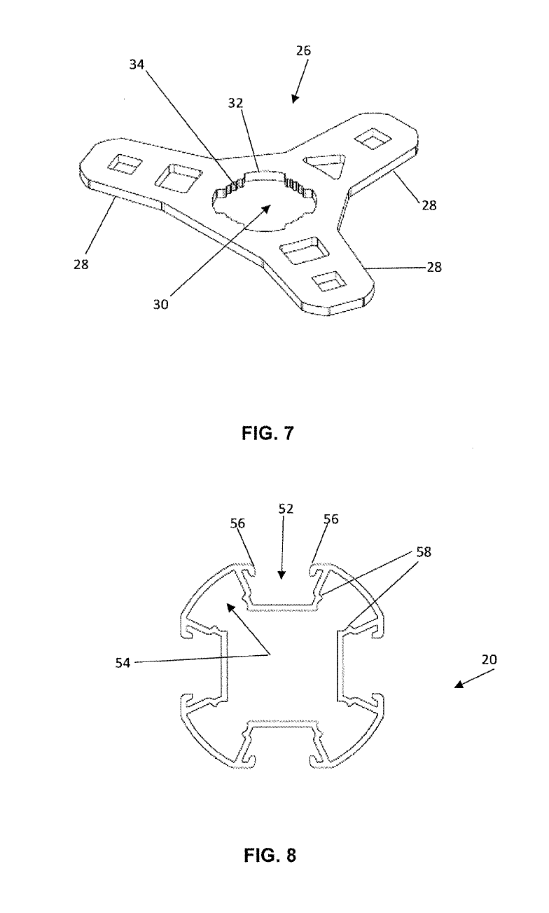

The base structure 18 illustrated comprises a base plate 26 (see FIG. 7) which has three arms 28 radiating from a central area in which there is an opening 30. The periphery of the opening 30 has four equally spaced recesses 32 in it. The parts of the periphery of the opening 30 between the recesses are formed with sets of teeth 34.

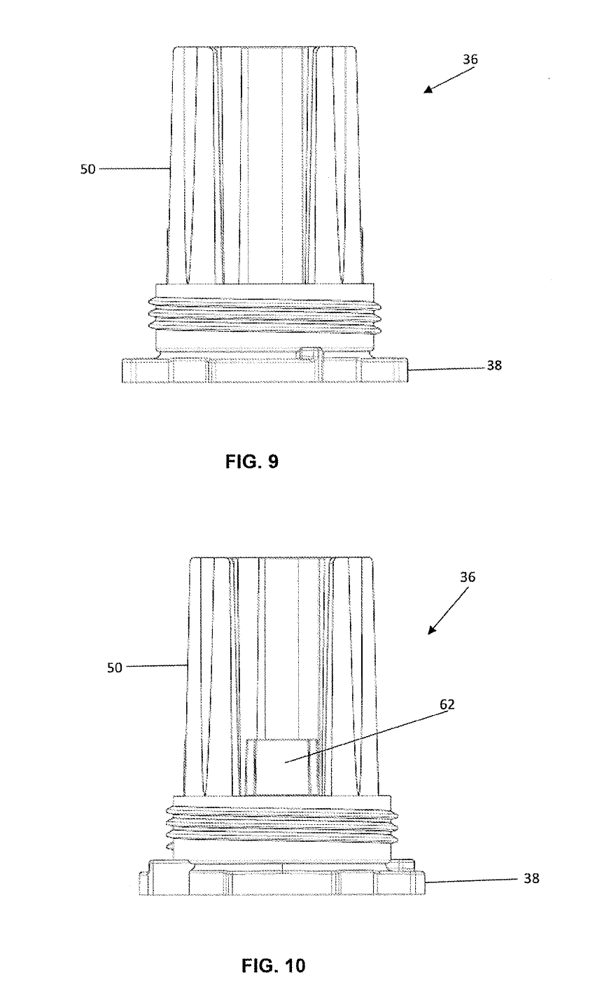

A connector 36 (see also FIGS. 9 and 10) has a base section from which four locking tabs 38 protrude. To attach the connector 36 to the base plate 26, the tabs 38 are passed through the recesses 32 and the connector 36 is then turned so that the tabs 38 lie below the parts of the base plate 26 which are between the recesses 32.

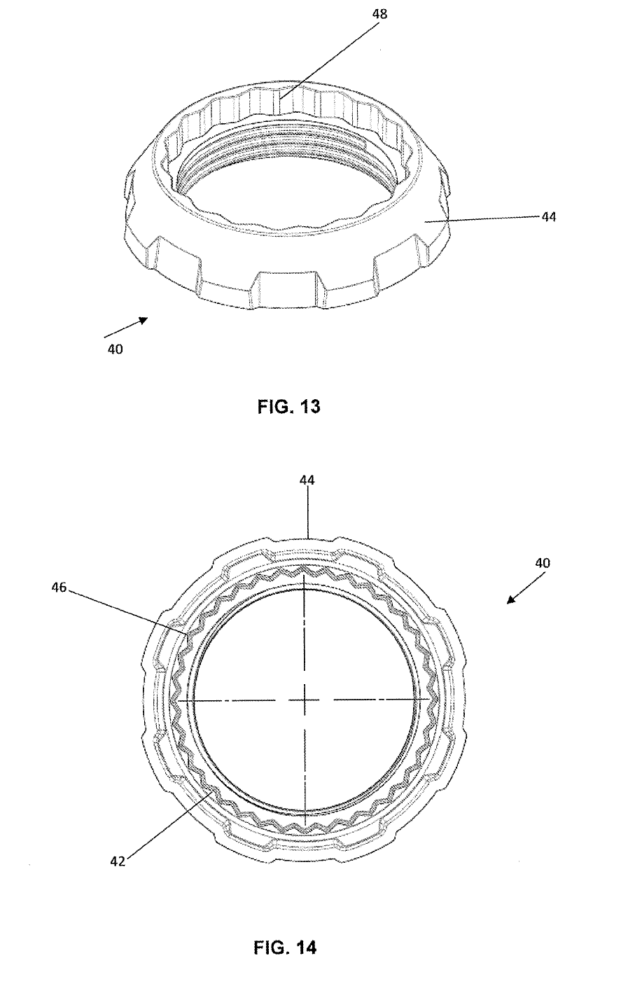

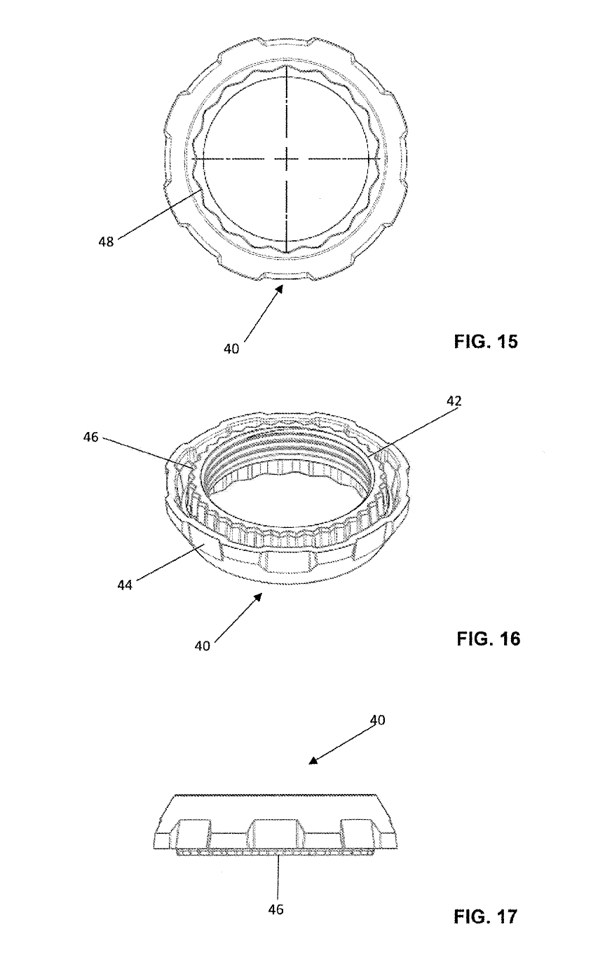

The periphery of the connector 36 is externally threaded and a locking ring 40, which is internally threaded, is screwed onto the connector 36. The ring 40 (see FIGS. 13 to 17) has an inner skirt 42 and an outer skirt 44 which merge along their upper edges. The outer periphery of the inner skirt has a circumferentially extending array of teeth 46. The ring 40 also has a plurality of serrations 48 on its inside surface above its internal threading (see FIG. 13).

The upper part of the connector 36 is in the form of a spigot 50 which is externally shaped so as to match the inside configuration of the extrusion 20. During assembly the spigot 50 is pushed into the lower end of the extrusion 20.

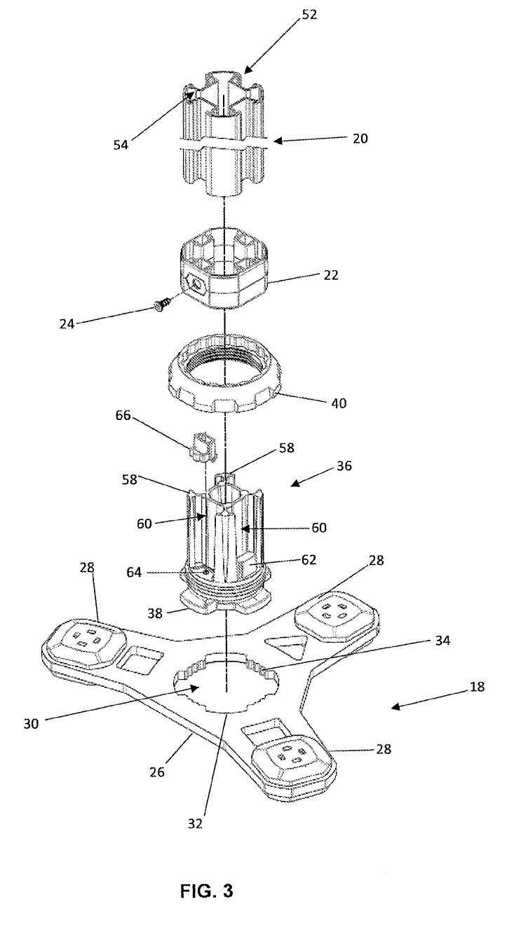

The shape of the spigot 50 is best seen in FIG. 3 and that of the extrusion in FIG. 8. The extrusion 20 is shaped so as to provide four vertically elongate external recesses 52 and four internal recesses 54. The recesses 52 widen towards their radial outer open edges and have retaining lips 56 on each side of the open edge thereof. The recesses 54 narrow towards their radially inner open edges.

The spigot 50 has four generally T-shaped ribs 58 which fit in the internal recesses 54. Between the ribs 58 there are recesses 60 which receive those parts of the extrusion 20 which are between the internal recesses 54.

At the lower end of three of the recesses 60 there are upstanding posts 62 (see FIGS. 3,10 and 11). The posts 62 (see FIG. 2) fit into the external recesses 52 of the extrusion 20, the extrusion entering the gap between each post 62 and the spigot 50 of the connector 36.

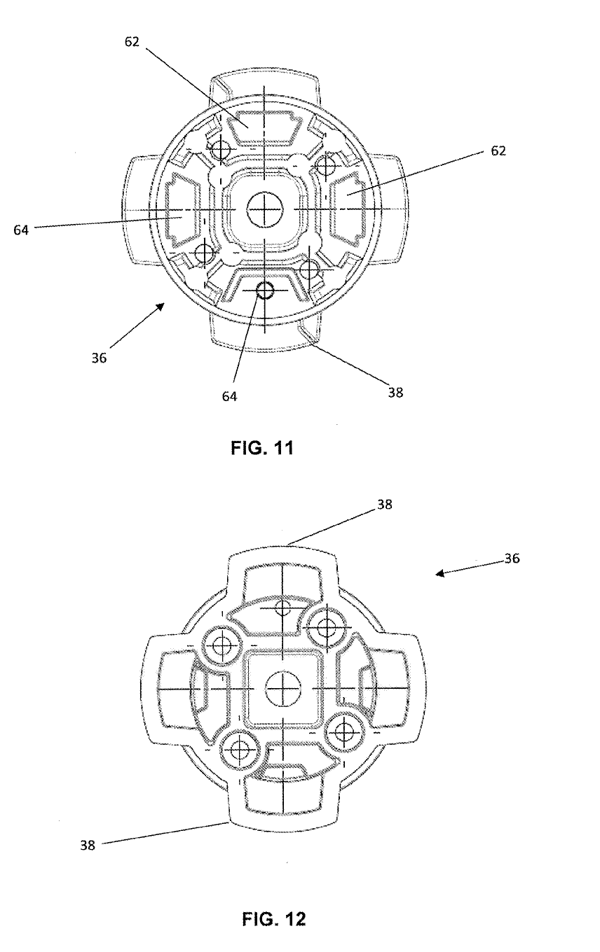

The lower end of the fourth recess 60 does not have a post in it. Instead, as best seen in FIG. 11, there is a vertically extending bore 64.

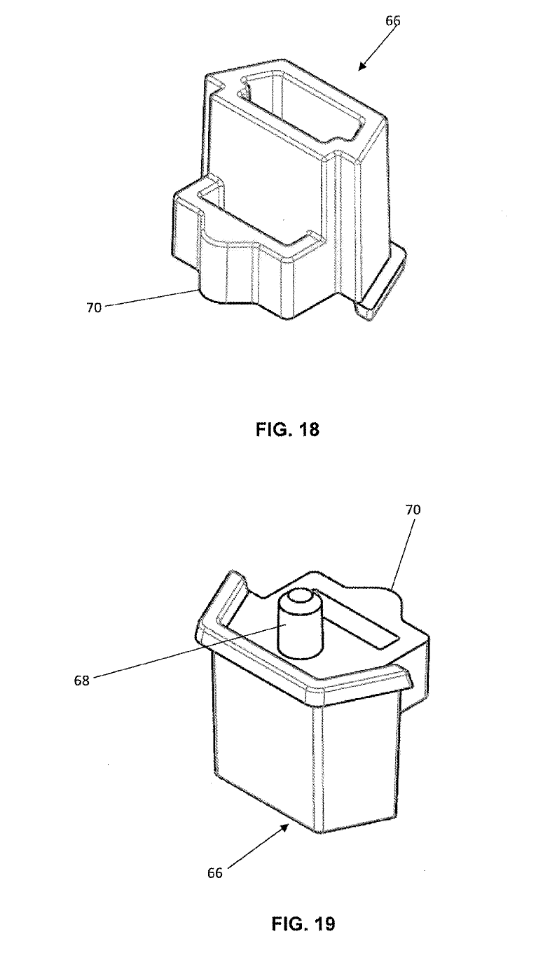

An indexing element 66 (FIGS. 18 and 19) has a spigot 68 which fits in the bore 64 to locate the element 66 at the lower end of the fourth recess 60. The element 66 also has a laterally projecting flexible tooth 70.

The base plates 26 are not necessarily of the same thickness due to manufacturing variations. To ensure a tight fit between the column and the base structure, the ring 40 is screwed onto the threading of the connector 36 until it is against the top surface of the plate 26 and can be adjusted on the threading of the connector to increase or decrease the gap between the locking tabs 38 of the connector 36 and the ring 40 to match the thickness of the base plate 26.

To ensure tighter clamping of the ring 40 onto the plate 26, the threading of the connector 36 and the ring 40 can be left hand threading. In this form the connector 36 is pushed through the plate 26 and then turned clock-wise to rotate the tabs 38 so that they lie under the parts of the plate which carry the serrations 34. Co-operation between the teeth 34 of the base structure 18 and the teeth 46 prevents the ring 40 from rotating. It consequently moves axially along the left hand threading and is forced against the top of the plate 26.

The tooth 70 co-operates with the serrations 48 and ensures that the teeth 46 are always in an aligned position with the teeth 34 on the base plate 26. As the tooth 70 is flexible, it “snaps” from one of the troughs between peaks of the serrations to the next. The clicking sound made enables the user to determine how much it has been necessary to adjust the locking ring 40.

To assemble the structure described the locking ring 40 is screwed onto the connector 36. The element 66 is then inserted into the space provided therefor, the spigot 68 fitting into the bore 64. The rim at the base of the element 66 fits into the corresponding indentation in the connector 36. The connector 36 is then screwed into the extrusion 20. The extrusion 20 presses down on the rim at the base of the element 66 firmly securing it in place without requiring other fasteners.

Pairs of pads 72 (see particularly FIG. 6) are pressed into co-operating relationship with one another, one from above and one from below, through holes in the base plate 26. The pads 72 have formations which snap engage with one another. The pads 72 form the ground engaging surfaces of the stand.

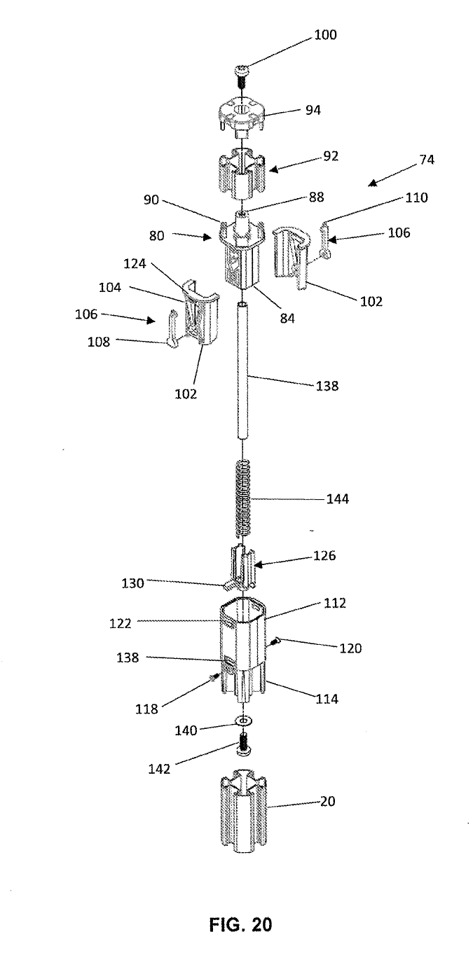

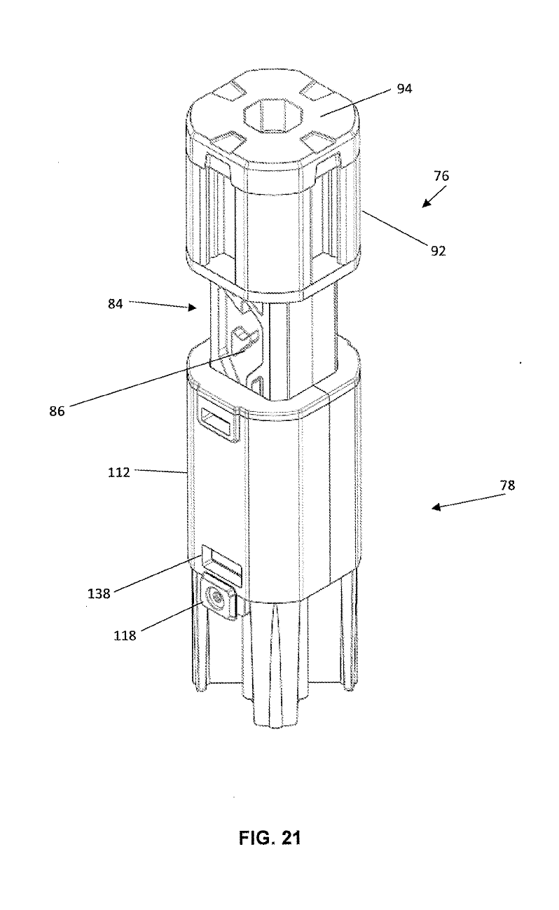

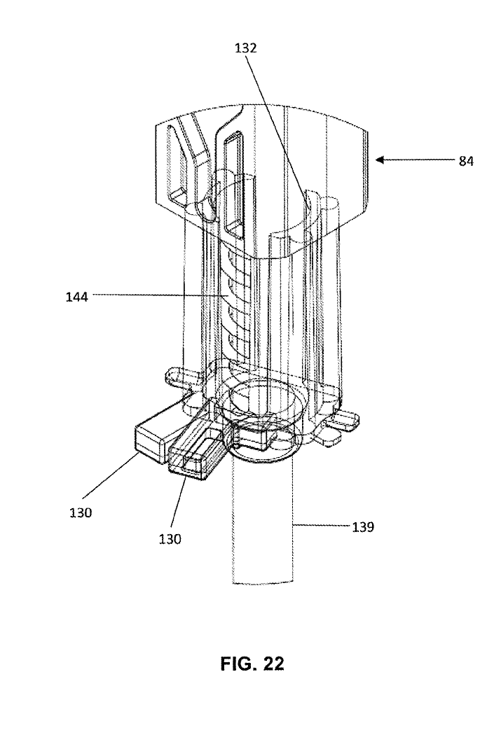

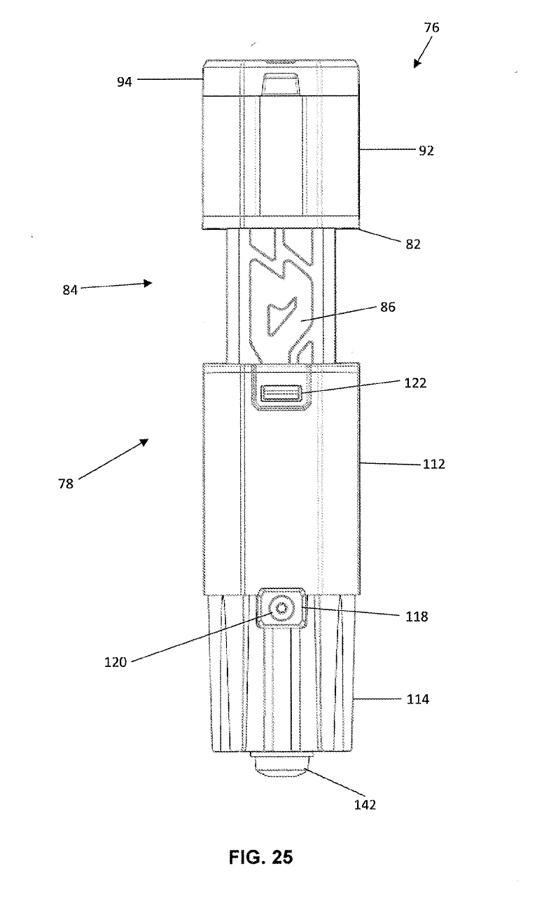

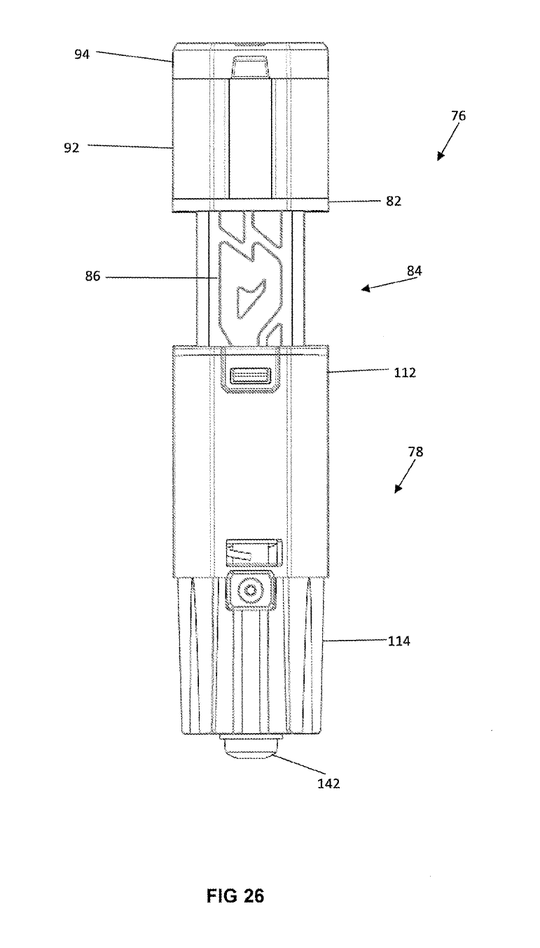

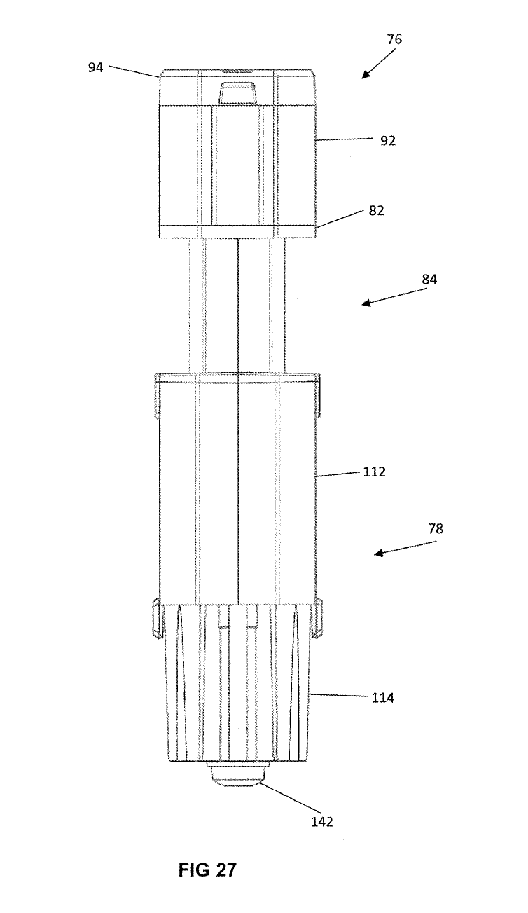

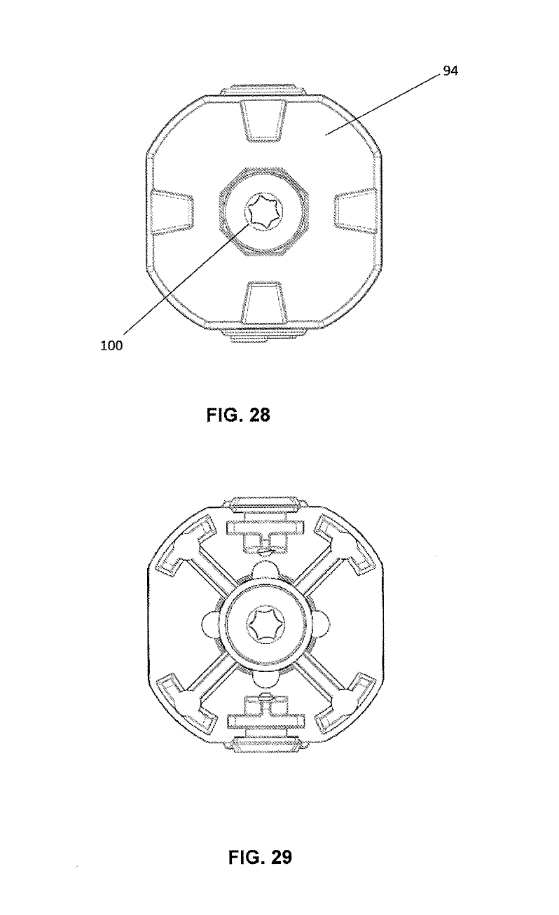

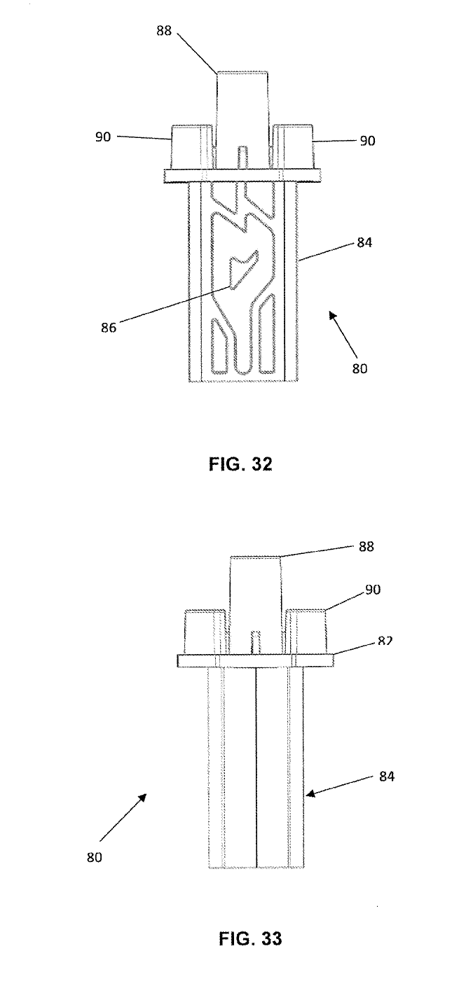

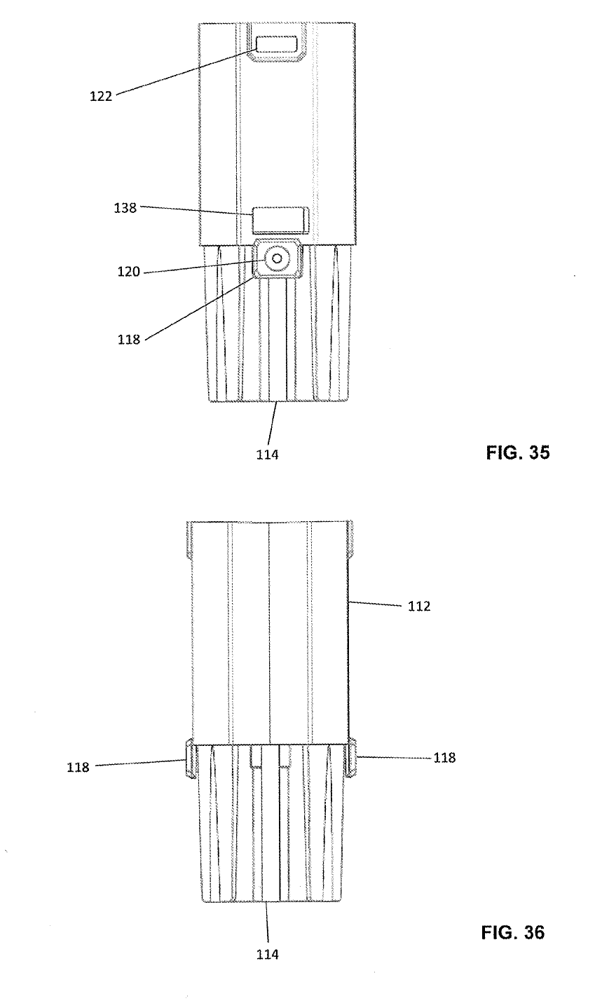

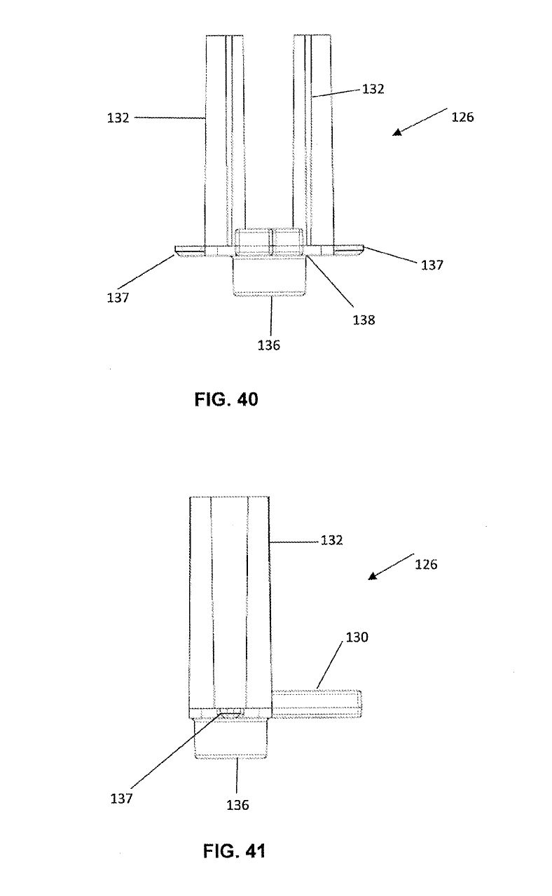

At the upper end of each column 12 there is a tensioning mechanism, generally designated 74, and illustrated in FIGS. 20 to 41.

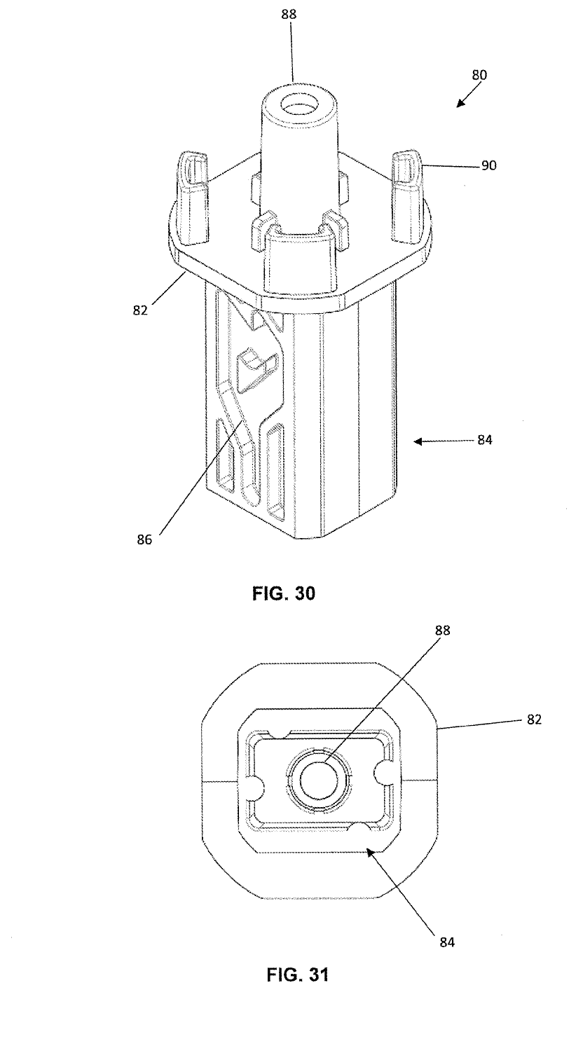

The mechanism 74 comprises a vertically movable part generally designated 76 and a part designated 78 which is fixed to the extrusion 20. The main component of the movable part 76 is designated 80 and is shown in FIGS. 30 to 33. It comprises a platform 82 below which there is a hollow section 84 of generally square cross-sectional shape with cam tracks 86 in two opposed surfaces thereof. Above the platform 84 there is a sleeve 88, the bore in the sleeve 88 passing through the platform 82 and opening into the hollow interior of the section 84.

Four circumferentially spaced locating lugs 90 protrude upwardly from the platform 82. These are configured and arranged so that they can enter the internal recesses 54 of a short length 92 of the extrusion 20.

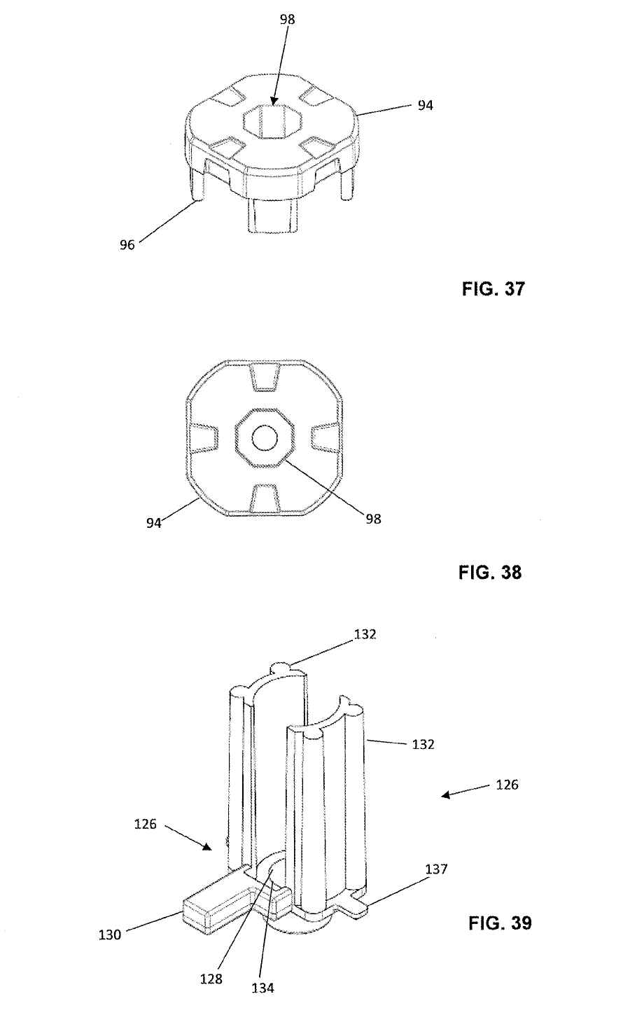

A cap 94 (FIGS. 37 and 38) has similar but depending lugs 96 which fit the recesses 54 to trap the length of extrusion 92 between the platform 82 and the cap 94. The cap 94 has a central vertical bore 98 the upper part of which is configured to receive the hexagonal head of a cap screw 100 (FIG. 20).

The section 84 with the cam tracks 86 in it is within a sheath comprising two half shells 102 (FIG. 20). There is a window 104 in each half shell. Each window is keyhole shaped having a circular lower part and an upper part which widens in the upward direction. The lower part mounts a cam follower 106 which has a disc-like mounting part 108 and a finger 110 which co-operates with the adjacent cam track 86.

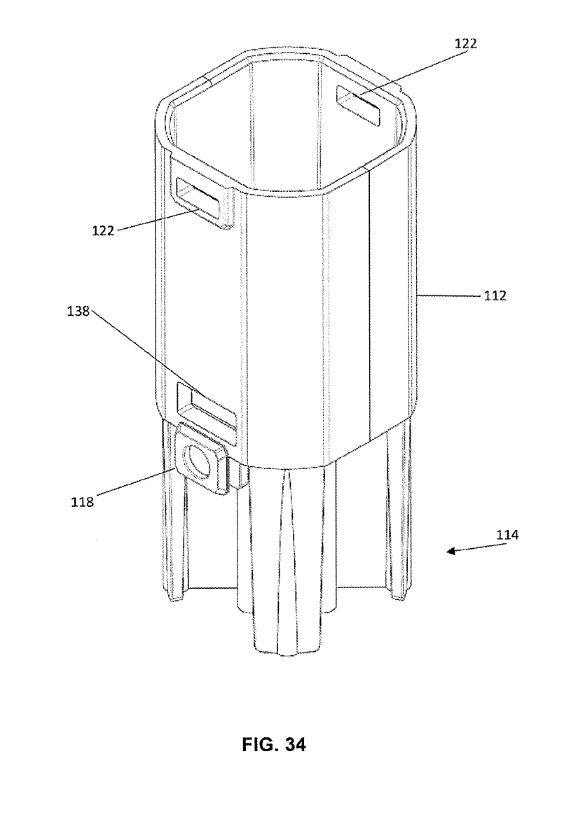

A mounting sleeve 112 (FIGS. 34 to 36) has a lower part in the form of a spigot 114 which is configured with ribs and grooves so that it fits tightly in the upper end of the extrusion 20.

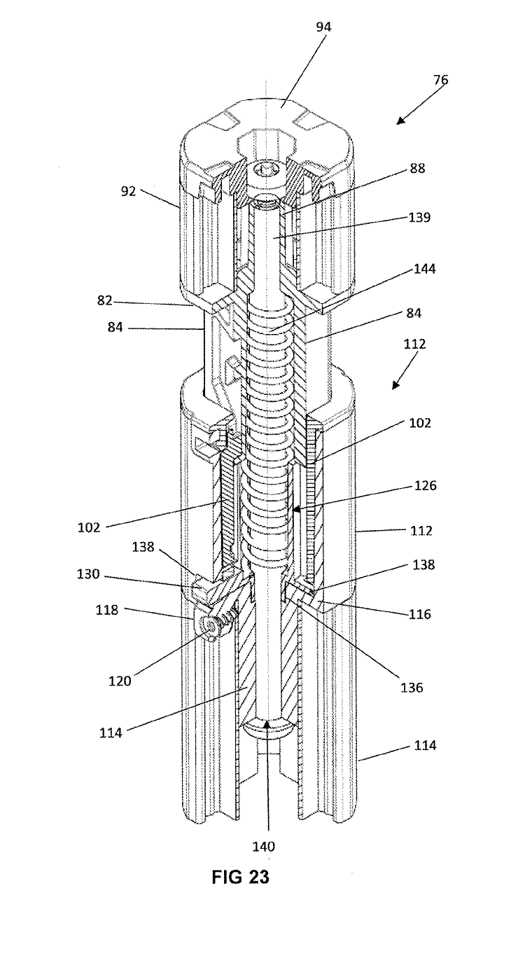

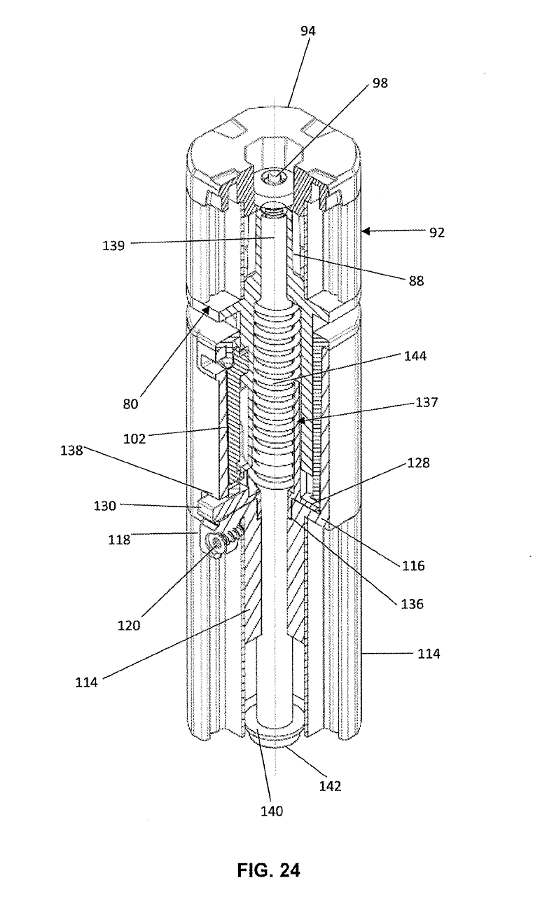

A horizontal wall 116 (FIGS. 23 and 24) forms the boundary between the hollow interior of the upper part of the sleeve 112 and the spigot 114. The shells 102 are in the hollow upper part of the sleeve 112.

Securing tabs 118 each with a horizontal bore for receiving a screw 120 (FIGS. 23 and 24) are provided, the screws 120 securing the sleeve 112 to the extrusion 20.

Diametrically opposed openings 122 are provided at the upper end of the sleeve 112 and the shells 102 have protrusions 124 which fit in the openings 122 during assembly so that the shells 102 cannot move with respect to the sleeve 112.

The blocking element 126 shown in FIGS. 39 to 41 forms part of the fixed component and comprises a base 128 from which an actuating member 130 protrudes laterally. Two posts 132 extend upwardly from the base 128 and there is a central hole 134 in the base 128. A spigot 136 extends downwardly below the base 128 and the hole 134 extends through the spigot 136. Diametrically opposed locking elements 137 protrude from the posts 132. On the underside of these elements there are protrusions or recesses which co-operate with corresponding recesses or protrusions of the flange 116 to lock the element 126 in its position of adjustment.

The wall 116 of the sleeve 112 has a central opening and the spigot 136 fits in this so that the element 126 is free to rotate (see FIGS. 23 and 24). The actuating member 130, on assembly, projects through a rectangular opening 138 in the sleeve 112.

The section 84 of the main component 80 is configured such that when the locking element 126 is in one position, the posts 132 slide into its hollow interior. When the operating element 130 is used to rotate the element 126 to its other position, the upper ends of the posts 132 encounter the downwardly facing surface of the section 84 and prevent the component 80 from moving down.

A hollow rod 139 has its upper end secured to the movable part 76 by the screw 100 (FIG. 20) and passes through the central openings of the main component 80 and the sleeve 112. At the lower end of the rod there is a washer 140 which is secured to the rod by means of a screw 142. The washer 142 acts as a stop which encounters the underside of the spigot 114 and limits upward movement of the part 76.

A spring 144, through which the rod 139 passes, acts between the fixed and movable parts 76, 78 to urge the movable part 76 to its uppermost position.

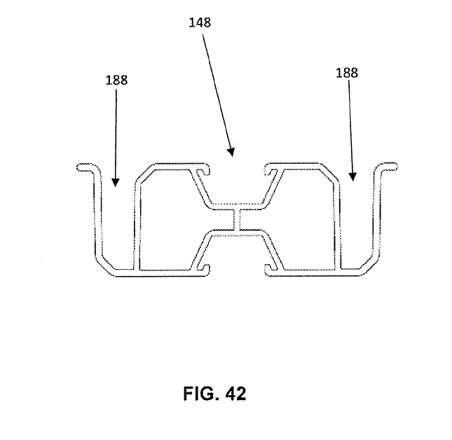

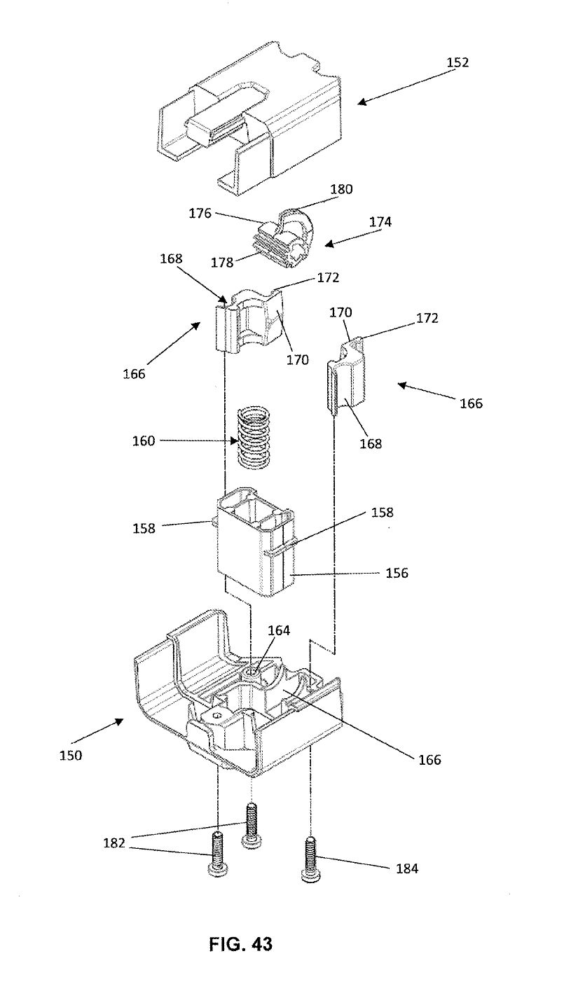

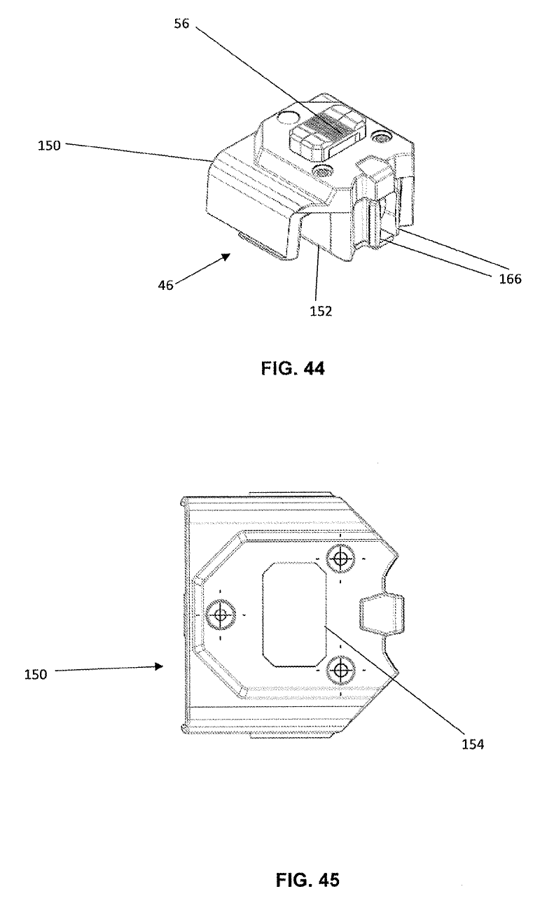

A releasable securing mechanism 146 of the form shown in FIGS. 43 to 45 is provided at each end of each crossbar. The main component of each crossbar is constituted by an aluminium extrusion 148 having the configuration shown in FIG. 42.

The mechanism 146 comprises housing parts 150 and 152. The housing part 150 is the upper part and the housing part 152 is the lower part. The structure is shown inverted in FIG. 43 to facilitate illustration. The housing part 150 has a rectangular central opening 154 (FIG. 45) which receives an actuating button 156 (FIG. 47) of the same rectangular configuration as the opening 154. There are protruding ribs 158 on each end face of the button 156 which act as stops to limit upward movement of the button 156 under the action of a spring 160 which is between the button 156 and the casing part 152. The button has a series of horizontally extending ribs 162 on one side face thereof (see FIG. 47).

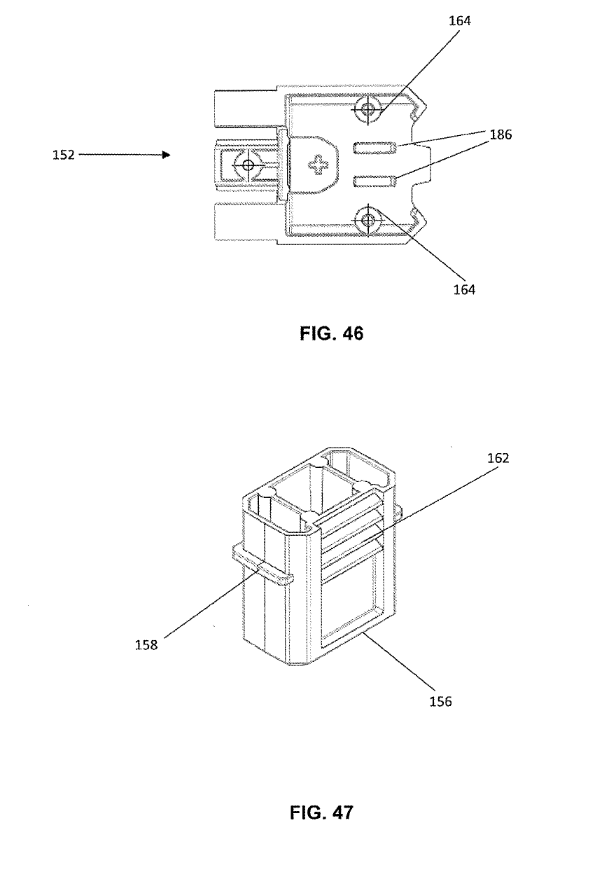

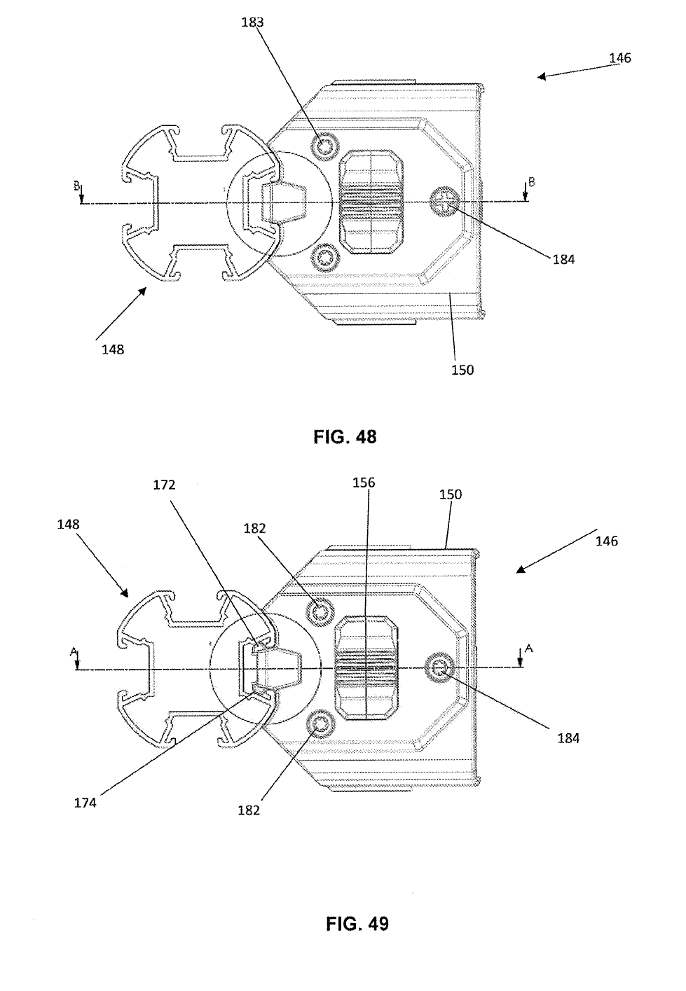

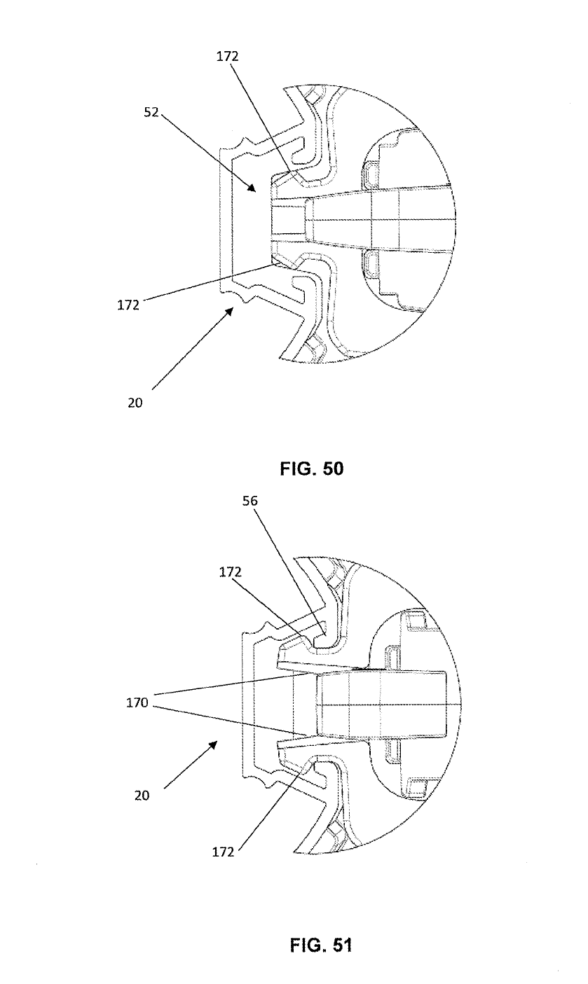

The casing part 150 (see FIG. 46) has two integral posts 164 which form pivots for two jaws 166. Each jaw 166 is formed with a part cylindrical recess 168 into which one of the posts 164 fits. At the end remote from the recess 168 each jaw has a latching blade 170 (see particularly FIGS. 50 and 51) which has a latching bead 172 along the free edge thereof. There is a recess behind each bead 172.

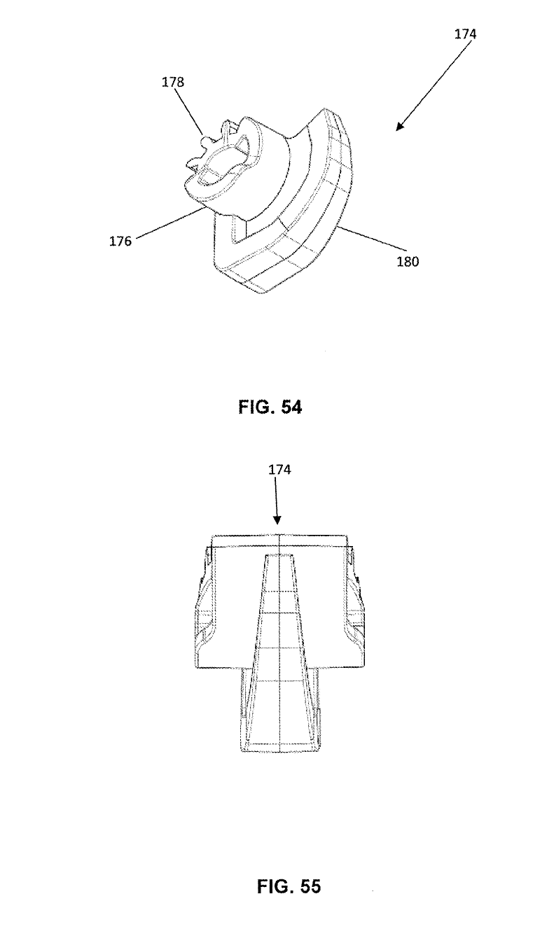

The jaw actuating component 174 (FIGS. 54 and 55) comprises a cylindrical portion 176 which has teeth 178 on its outer surface. A cam 180 protrudes from the portion 176, the cam being wedge shaped and tapering from one end to the other as best seen in FIG. 54. The thicker part of the cam 180 is normally between the jaws 166.

The housing parts 150, 152 are secured together by two screws 182 (FIG. 43). Once the housing parts are assembled they together have an end configuration which matches that of the extrusion 148. The extrusion slides into the housing and the housing is fixed to the extrusion by a third screw 184.

Two rectangular posts 186 (FIG. 46) are provided adjacent the posts 164.

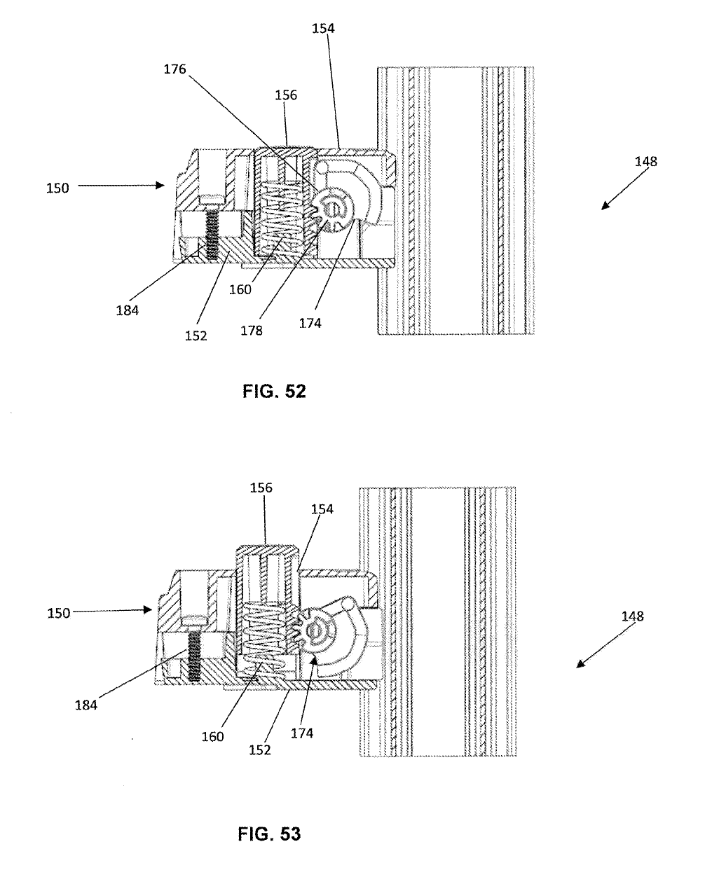

When the button 156 is pressed down from the position shown in FIG. 52 to the position shown in FIG. 53, the ribs 162 on the side of the button, by engaging with the teeth 178, rotate the actuating component 174. This causes the thinner part of the cam 180 to move between the jaws 166.

In this condition of the jaws, as seen in FIG. 50, the beads 172 can be inserted into one of the recesses 52 of the extrusion 20. When pressure on the button 156 is released, the spring 160 pushes the button back to its upper position rotating the component 174 and hence the cam 180. The jaws 166 move outwardly to the position shown in FIG. 51 in which the lips 56 of the extrusion 20 are in the recesses behind the beads 172.

In use of the stand, a printed panel of fabric or sheet synthetic plastics material is fitted to the upper and lower crossbars 14 and 16. Along the upper and lower edges of the panel there are strips (not shown) around which the upper and lower edge zones of the panel are wrapped. It will be understood that the grooves 188 (see FIG. 42) of the upper extrusion 148 face upwardly and the grooves 188 of the lower extrusion 148 open downwardly.

The upper components 76 are pressed down into the lower components 78. The latching mechanisms 126 are in the positions in which they do not interfere with the downward movement of the components 76.

The followers and cam tracks constitute a “click to lock”, “click to release” mechanism. As the components 76 are pressed down to the full extent possible and then released, the fingers 110 are guided by the cam tracks 86 to a position in which they interlock with parts of the cam tracks that limit upward movement of the components 76.

Whilst the components 76 are held in the position in which they are close to, but not at, the limit of their downward movement, the strips around which the panel's edges are wrapped are pressed into the grooves 188 of the extrusion 148 (see FIG. 42).

The components 76 are then pressed down to the limit of their downward movement and released. This frees the fingers 110 from those parts of the cam tracks that held the components 76 in their slightly raised position, and the springs 144 are then effective to raise the components 76 to their full height, thus tensioning the panel.

The latch mechanisms 126 are then rotated to their operative positions to prevent the components 76 accidentally being pressed down.

It is possible to use columns 12 and crossbars 14, 16 to construct a frame work which can be used as, for example, a display stand. A rectangular framework can be constructed using four columns, four upper crossbars and four lower crossbars. The latching mechanisms, once engaged prevent the top frame comprising four or more upper crossbars being pressed down towards the lower frame.

Each connector of the upper crossbar is between the platform 80 of the component 76 and the cap 94 and cannot slide up, or down, if pressed upon or pulled. Likewise, the lower connectors are between the rings 40 and the collars 22 and are hence prevented from moving up or down.

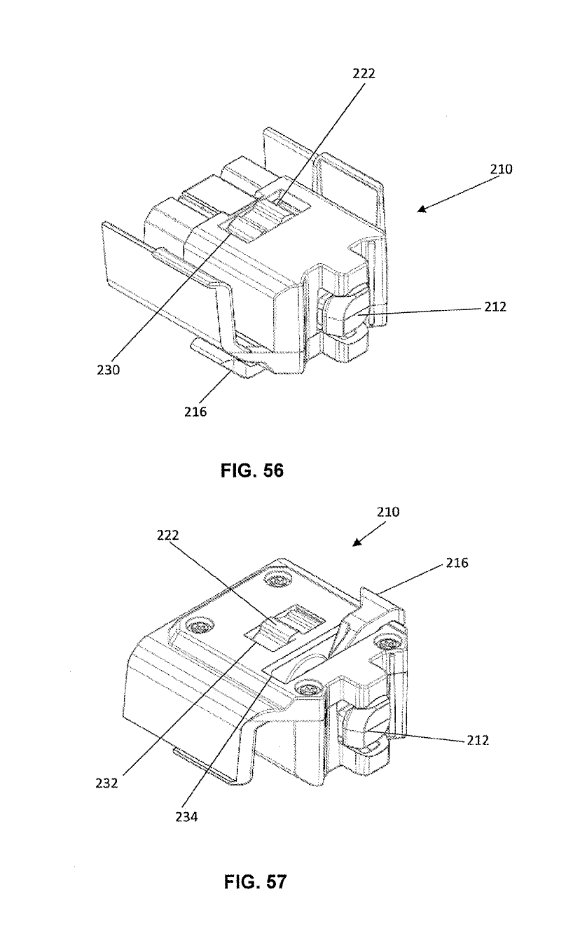

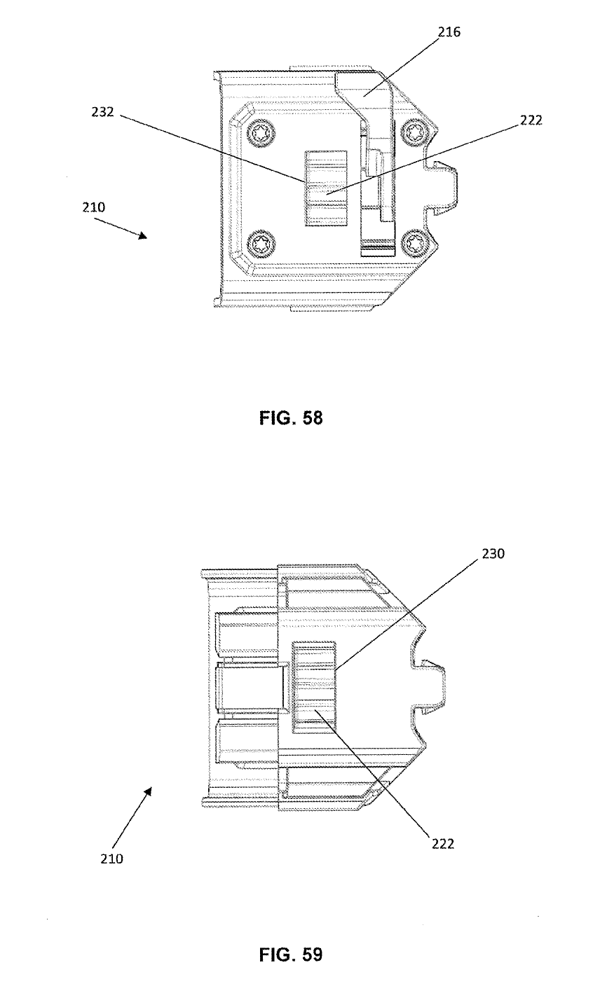

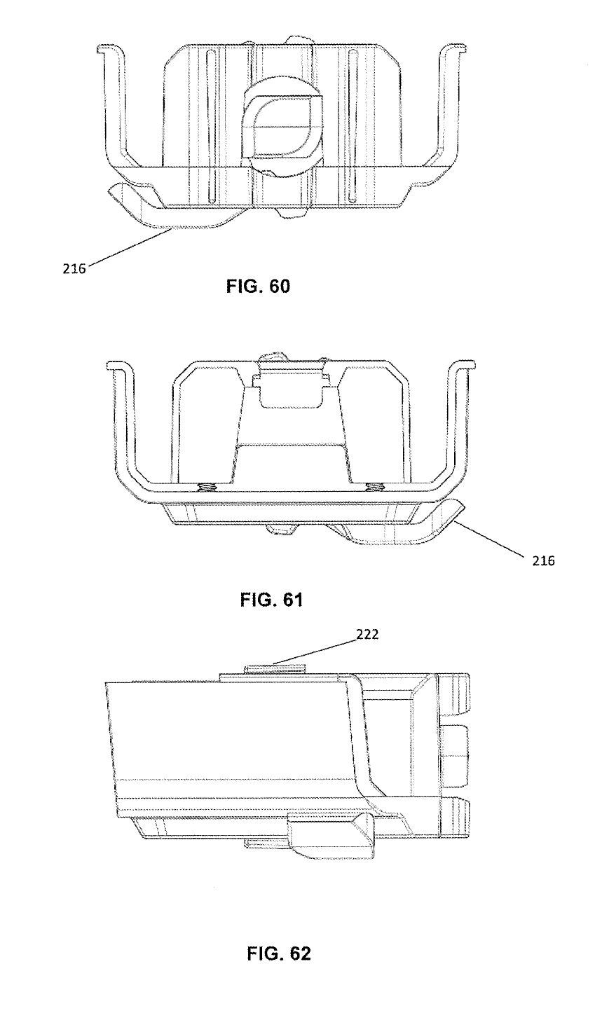

Referring now to FIGS. 56 to 62, the releasable securing mechanism illustrated is designated 210 and has a two part outer casing which is similar to that of FIGS. 43 etc. The internal structure is, however, different.

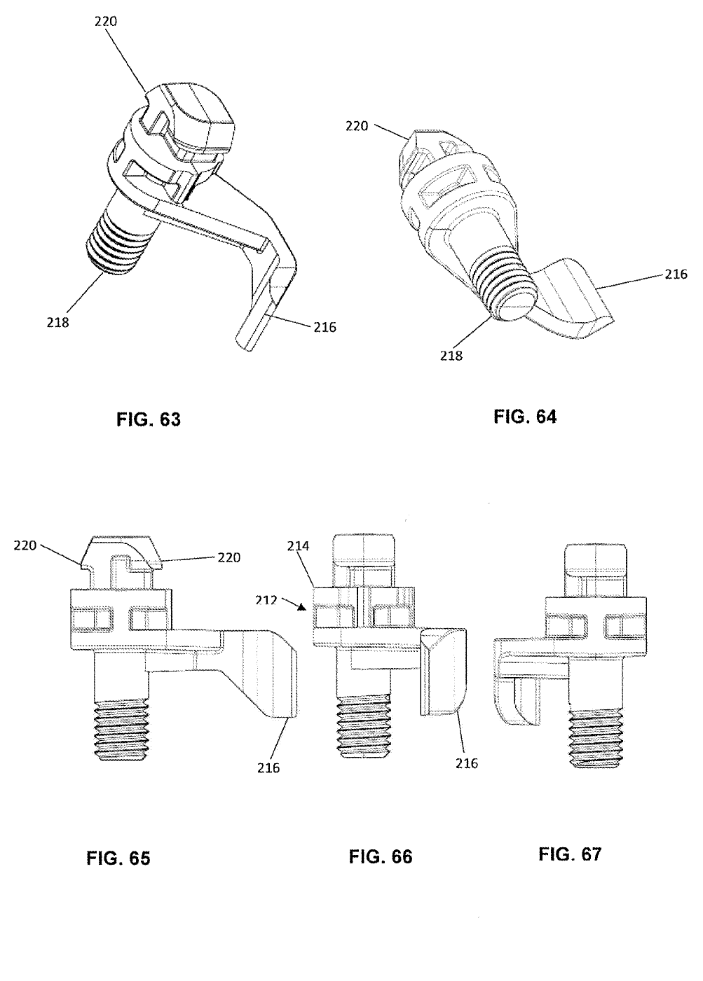

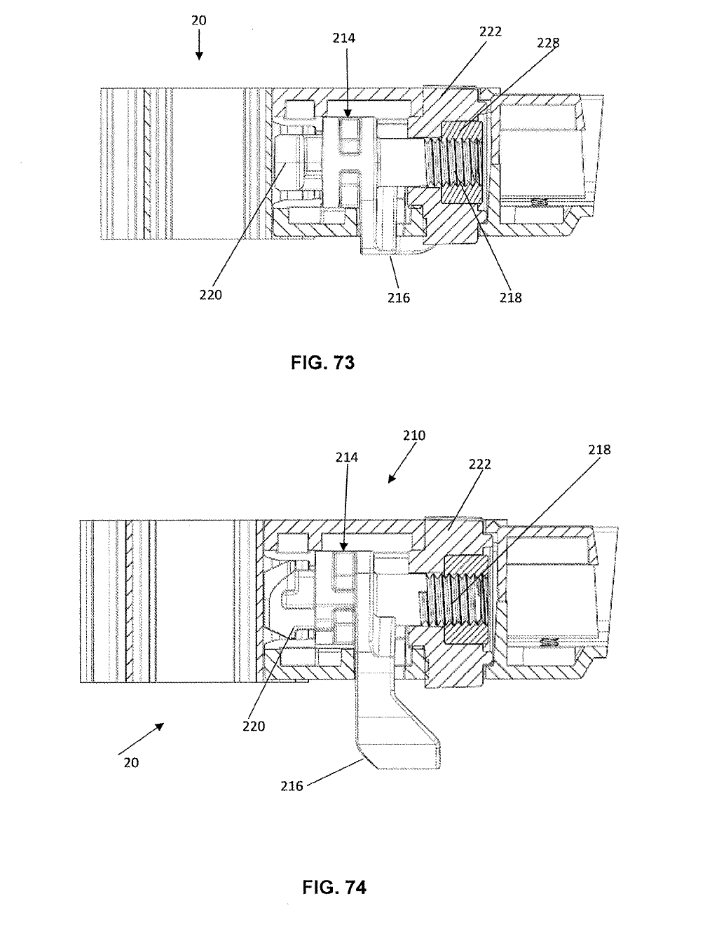

An actuating element 212 is shown in FIGS. 63 to 67 and comprises a body 214 of generally cylindrical form from which a lever 216 protrudes. One end portion of the body 214 is in the form of a threaded shaft 218 and the other end portion has an opposed pair of locking tabs 220. These tabs can also be seen in FIGS. 73 and 74.

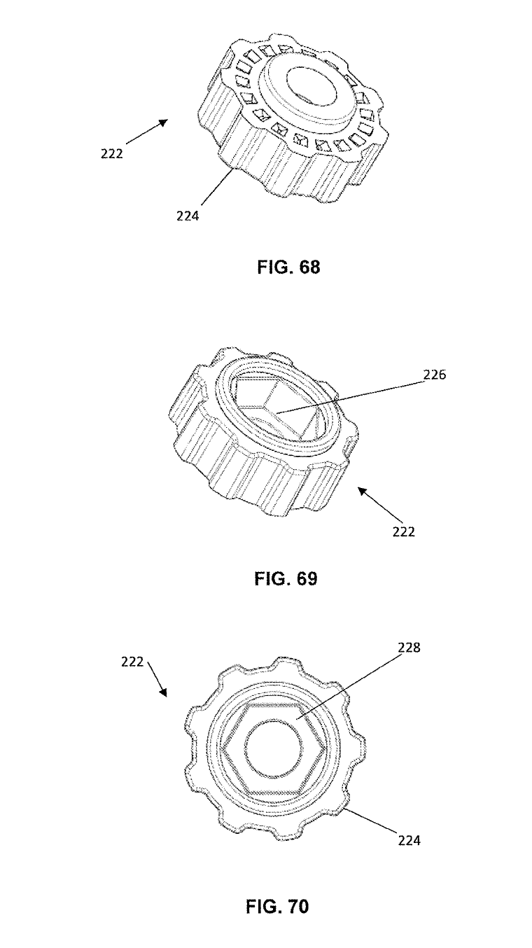

A wheel 222 is shown in FIGS. 68 and 69 and comprises an outer ring 224 which has a cavity 226 (FIG. 69) for receiving a nut 228 (FIG. 70). The threading of the nut 228 is compatible with that of the shaft 218.

The casing of the mechanism 210 has top and bottom openings 230 and 232 through which the wheel 222 protrudes. It also has a slot 234 (FIG. 57) through which the lever 216 protrudes.

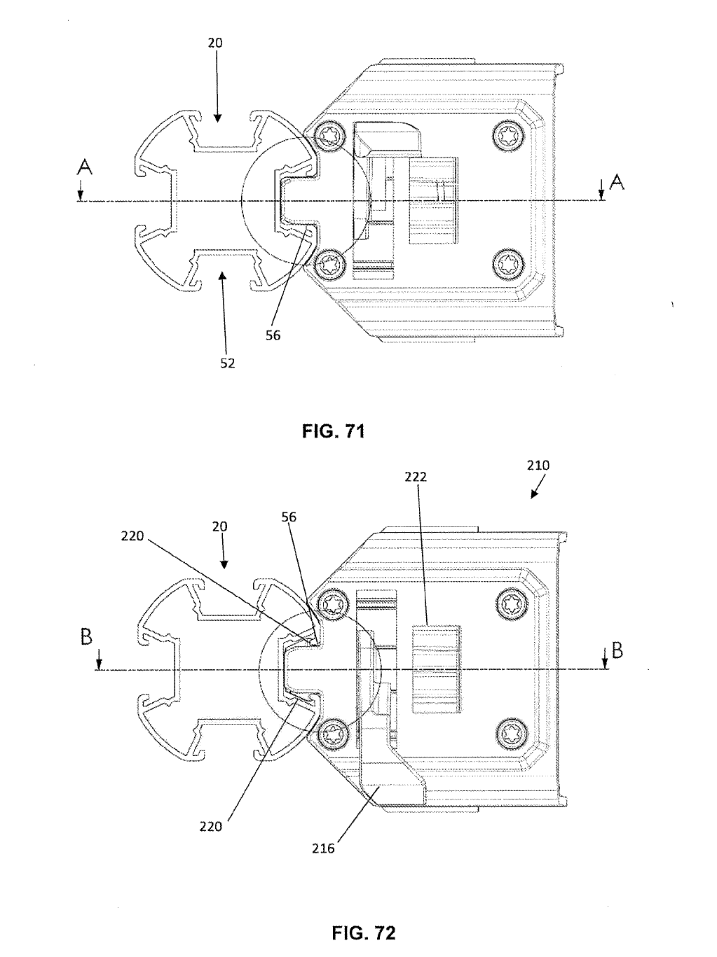

Referring now to FIGS. 71 to 74, the extrusion designated 20 is as shown in FIG. 8. The mechanism 210 is presented to the right hand recess 52 with the tabs 220 positioned one above the other so that they can freely enter the recess. The lever 216 is then turned through ninety degrees to rotate the body 214 in the casing so that the tabs 220 move from the position shown in FIG. 71 to the position shown in FIG. 72 so that they move behind the lips 56 of the extrusion 20.

To enhance the grip between the tabs 220 and the lips 56, the wheel 222 is rotated on the shaft 218. As the wheel is trapped in the openings 230, 323 it cannot move axially and hence it is the body 214 that moves axially, pulling the tabs 220 against the lips 56.

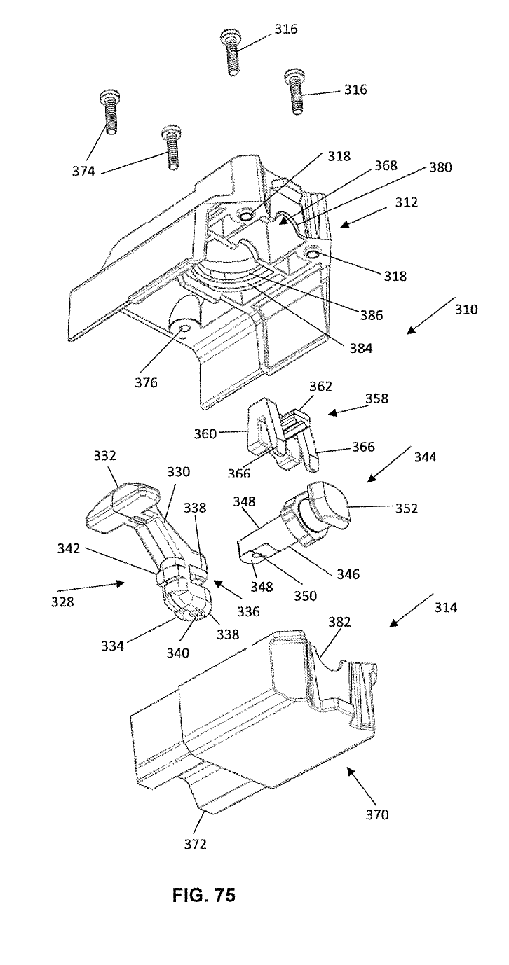

The further form of releasable mechanism illustrated in FIG. 75 etc is designated 310 and comprise two casing parts 312, 314. When secured together by two screws 316, the casing parts form a casing which fits into the extrusion 148 (FIG. 42). The screws pass through holes 318 in the casing part 312 and into blind tapped bores 320 (FIG. 80) in the casing part 314.

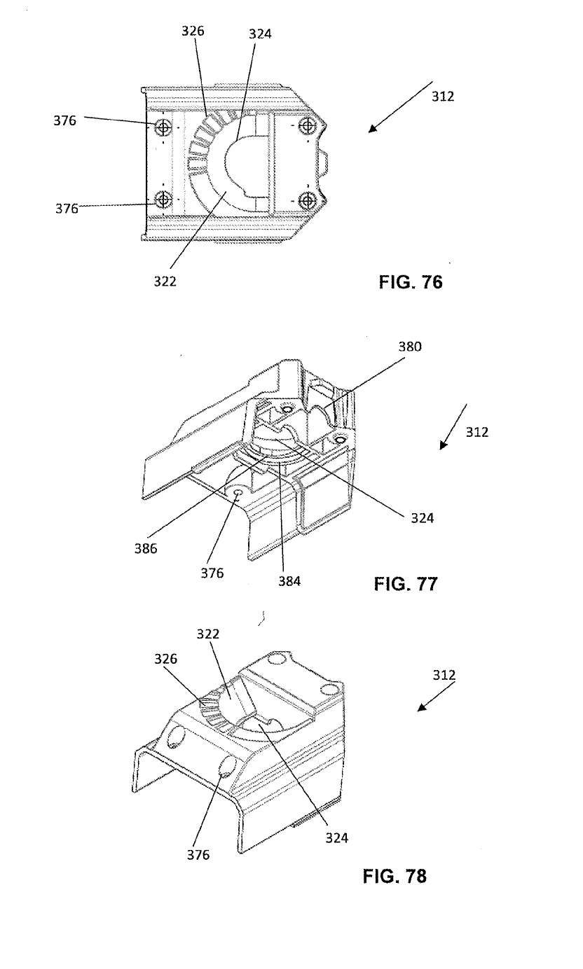

There is a well of semi-circular configuration in the casing part 312 (FIGS. 76 to 78), the curved wall 322 of the well sloping down to a hole 324 in the casing part 312. Adjacent the periphery of the well 322 there are a number of upstanding ribs 326.

The securing mechanism further includes a operating element 328 which comprises an arm 330 of T-shape with a cross bar 332 at one end and a pivot structure 334 at the other end. There is a slot 336 in the pivot structure 334, the provision of the slot giving rise to a fork having upper and lower tines 338. The tines 338 have aligned bores 340 in them. The bores are not centrally placed but are offset from the centre line of the fork so that the distance from the bore to the periphery of the fork is not the same at all positions around the circumference. There is a circumferentially extending protrusion 342 on that face of the arm 330 which is opposite to that in which the slot 336 is formed.

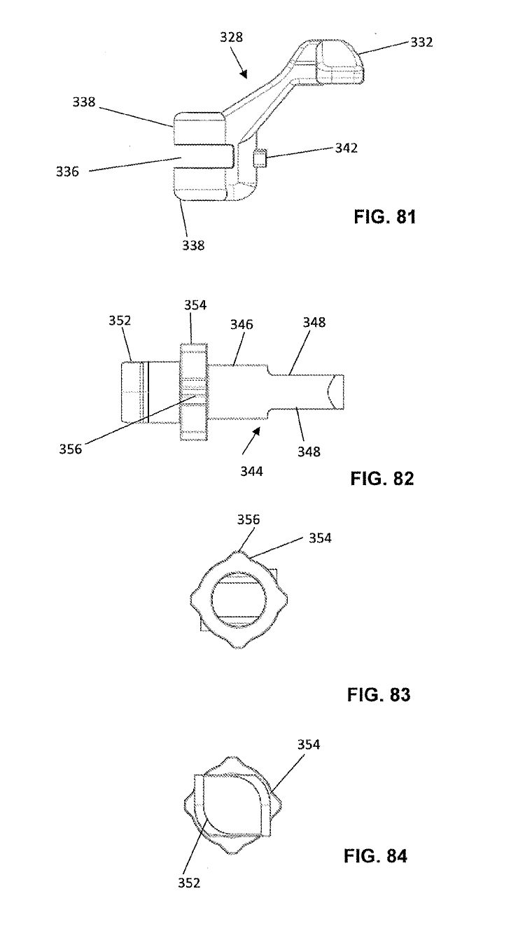

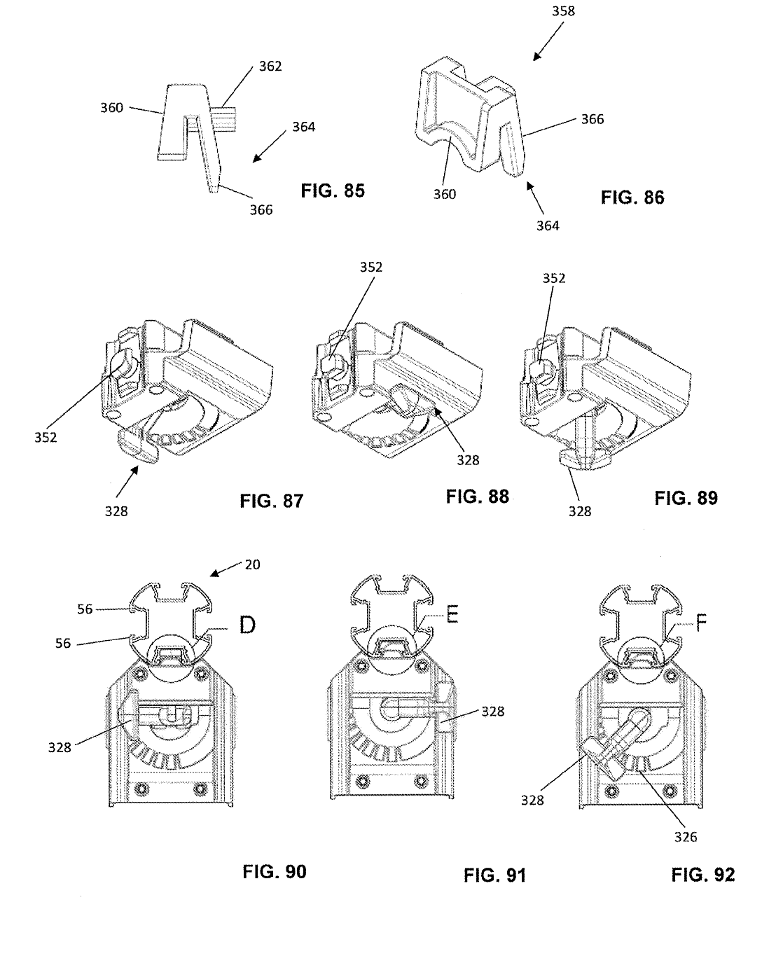

A latch is shown at 344 and comprises a shaft 346 one end of which is bounded by two flats 348. A bore 350 passes through the flats 348. At the other end of the shaft 346 there is a head 352 which is generally rectangular but with two opposed corners rounded-off (see FIG. 81). The “horizontal” dimension of the head 352, as viewed in FIG. 84, is smaller than the “vertical” dimension.

Between the flats 348 and the head 352 there is a ring 354 which has four lobes 356 protruding from its circular surface.

The mechanism 310 further includes a member 358 which exerts a force on the latch 344 tending to move it axially. The member 358 includes a mounting section 360 from which a location peg 362 protrudes. The peg has a groove in its lower surface. The member 358 further includes a fork 364 the arms 366 of which lie one on each side of the peg 362. The spacing between the arms is sufficient to allow the shaft 346 to pass between them.

The casing part 312 is formed on its inner surface with a recess 368 into which the member 358 fits.

Most of the components of the mechanism can be moulded in synthetic plastics material. The latch 344 is, however, of metal and can be a moulding of zinc alloy. A metal pin, which is not shown, passes through the bores 340 and the bore 350 thereby pivotally to secure the latch 344 to the element 328 with the part of the latch 344 which is constituted by the flats 348 between the tines 338.

The arms 366 of the fork 364 fit one on each side of the shaft 346.

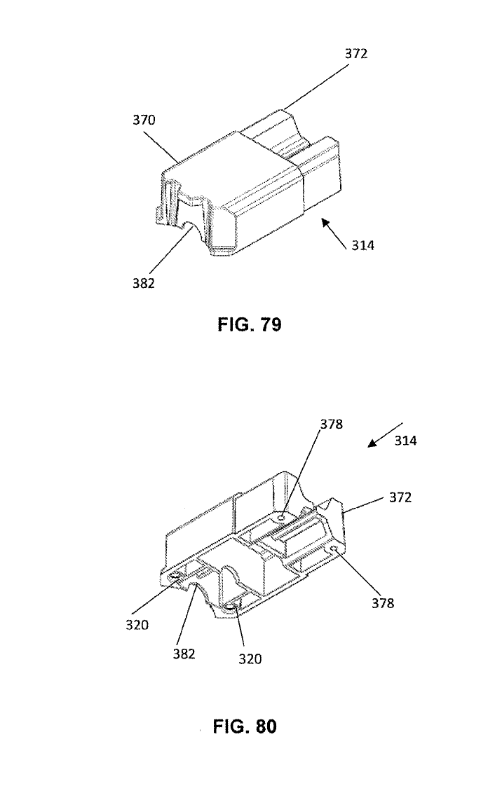

From FIGS. 75 and 79 it will be seen that the casing part 314 comprises a hollow section designated 370 and a solid section designated 372. The solid section 372, when the casing parts 312, 314 are fitted together, protrudes beyond the casing part 312 and fits into the end of the extrusion 148 which constitutes the upper and lower horizontals. Screws 374 (FIG. 75) passed through bores 376 of the casing part 312, through holes in the extrusion and into tapped bores 378 of the casing part 314 secure the mechanism to the extrusion.

The casing parts 312, 314 have semi-circular recesses 370 and 382 (see FIG. 75) which, on assembly, form a circular opening through which the latch 344 passes with the head 352 outside the casing.

Referring now to FIGS. 87 to 92, the mechanism is secured to the extrusion 20 by presenting it to the extrusion in the configuration shown in FIGS. 87 and 90. The head 352 has its smallest dimension in the horizontal direction and in this position it is small enough to enter one of the recesses 52 of the extrusion 20. The operating element 328 is in the position illustrated.

The operating element 328 is then swung in an arc through 90° from the position shown in FIG. 87 to the position shown in FIG. 88. This movement is about the axis of the latch 344. The head 352 is turned through 90° so that its larger dimension now extends horizontally as shown in FIGS. 88 and 91. The edges of the head are now behind the lips 56 of the extrusion 20.

The fork 364 of the member 358 presses on the flat surface of the ring 354 and acts as a spring to hold the head 352 in the position in which it protrudes as far as possible form the casing. This prevents contact between the head 352 and the lips 56 of the extrusion 20 whilst, as described below, the head 352 is being turned.

A lobe 356 of the ring 354 fits into the groove in the underside of the peg 362 when the latch 344 is at both ends of its 90 degree rotational movement. This locks the latch 344 in the end position to which it has been rotated.

Finally, the element 328 is moved in a rotational movement about the axis of the metal pin which passes through the bores 340 and 350. This does not further rotate the head 352. However, the eccentric position of the bores 340 causes the pivot structure 344 to press on the curving surface 384 (FIGS. 75 and 76) of the casing which extends around the periphery of the hole 324 in the casing part 312. The element 328 and the latch 344 are shifted axially pulling the head 352 hard against the lips 56 and inhibiting slippage between the mechanism and the extrusion 20.

The movement also causes the protrusion 342 to move beneath the downwardly facing surface 386, FIG. 75, which is immediately above the surface 384. This prevents the arm 330 from being lifted from the position shown in FIGS. 89 and 92. Only if the arm 330 is returned to the position shown in FIG. 91 can it be lifted.

Engagement between the ribs 326 and the element 328 prevent the element 328 moving from the position to which it has been shifted when locking the mechanism to the extrusion.

1. A display stand including a tensioning mechanism connecting a horizontal to a column, the column including a fixed lower component and a movable upper component which is able to move up and down with respect to the fixed component, there being a mechanism for releasably securing the horizontal to the movable component, a “press to lock/press to release” latch joining the upper and lower components, and a spring for pushing the upper component upwards after said latch has been activated to release the upper component.

2. A display stand as claimed in claim 1, wherein said latch comprises a cam track and a cam follower which moves with respect to said track during relative movement between said components, the cam follower holding said upper component in an intermediate position after the latch has performed a locking movement, and releasing the upper component upon the upper component being pressed down to a lower position so that the latch performs a press to release operation.

3. A display stand as claimed in claim 2 and including two cam tracks which face in opposite directions and two shells which together form a sheath around the cam tracks, each shell having a window in it and there being a cam follower pivotally mounted on the outside of each shell, the followers extending through the windows and having fingers which move along the cam tracks.

4. A display stand as claimed in claim 1, and including a blocking element forming part of the fixed component and having an operative position in which in prevents said upper component being displaced downward with respect to the lower component and an inoperative position it which it permits said downward displacement.

5. A display stand as claimed in claim 4, in which said blocking element is mounted for rotation between said positions and includes upstanding posts which engage a downwardly facing surface of the movable component when in its operative condition.

6. A display stand as claimed in claim 5, wherein said blocking element is within a sleeve which has an opening in it and said blocking element includes an actuating member which protrudes from the sleeve through the opening.

7. A display stand as claimed in claim 1, wherein the mechanism for releasably securing the horizontal to the column comprises a pair of jaws which are moved by a cam to a withdrawn inoperative position and spring urged to their operative condition.

8. A display stand as claimed in claim 7 and including a button which a guided for rectilinear travel and which has a set of parallel teeth on one face thereof, said cam including a cylindrical portion which is toothed, the teeth of the button meshing with the teeth of the cam to rotate the cam when the button moves rectilinearly.

9. A display stand as claimed in claim 7, wherein said cam is wedge-like in form and increases in thickness from one end to the other, the cam being between said jaws.

10. A display stand as claimed in claim 1, wherein the releasable securing mechanism comprises a casing, a body rotatable in the casing and having a pair of diametrically opposed locking tabs, and an operating lever projecting from the casing through a slot in the casing for rotating the body through ninety degrees.

11. A display stand as claimed in claim 10, wherein the locking tabs protrude from opposite sides of a threaded shaft, there being an internally threaded wheel structure screwed onto said shaft, said wheel structure being restrained against axial movement so that, when the wheel structure is rotated, said shaft is moved axially.

12. A display stand as claimed in claim 1, wherein the releasable securing mechanism comprises a casing having a cam track, a shaft mounted for rotation in said casing and having a diametrically opposed pair of locking tabs, an operating element pivotally mounted on said shaft and including a cam, the operating element being displaceable in a first swinging movement for rotating said shaft about its axis thereby to displace said tabs between an operative position and an inoperative position and in a second movement which causes said cam to move over said cam track and displace said shaft axially.

13. A display stand as claimed in claim 12, wherein said operating element includes a fork having tines, said shaft being between said tines and there being a pivot pin passing through aligned bores in the tines and the shaft whereby said operating element can rotate with the shaft about its axis and relative to the shaft about the axis of said pivot pin.

14. A display stand as claimed in claim 12 and including surfaces on said casing and said operating element which are in contact and prevent said shaft being moved in said first swinging movement from the position it occupies when said tabs are in their operative position.

15. A display stand as claimed in claim 1 and including a base plate having an opening in it, the opening having recesses in the edge thereof, there being serrated edge sections of the opening between the recesses, a post, a connector at the lower end of the post, the connector having protruding locking tabs which can be passed through said recesses and which, when the post is rotated, move out of alignment with the recesses and secure the post to the base, a locking ring having teeth which interlock with said serrated edge sections to prevent the ring from rotating, and reverse threading on the ring and the connector which causes the non-rotatable ring to move axially into contact with the base plate when the post is rotated to latch it to the base.
